(19) United States
(12) Patent Application Publication
(10) Pub. No.: US 2021/0065708 A1
(43) Pub. Date: Mar. 4, 2021

(54) INFORMATION PROCESSING APPARATUS, INFORMATION PROCESSING SYSTEM, INFORMATION PROCESSING METHOD, AND PROGRAM

(71) Applicant: SONY CORPORATION, TOKYO (JP)

(72) Inventor: KANA NISHIKAWA, TOKYO (JP)

(21) Appl. No.: 16/964,803

(22) PCT Filed: Nov. 16, 2018
(86) PCT No.: PCT/JP2018/042410

§ 371 Date: Jul. 24, 2020

(30) Foreign Application Priority Data
Feb. 8, 2018 (JP) 2018-020826

(51) Int. Cl. G10L 15/22; G10L 15/08; G10L 25/51; G06F 3/16

(52) U.S. Cl. CPC G10L 15/22; G10L 15/08; G10L 2015/225; G06F 3/16; G10L 25/51

(57) ABSTRACT

An apparatus and a method which analyze a user utterance with high accuracy about to which one of a plurality of system utterances performed precedingly the user utterance corresponds as a feedback utterance are implemented. A user feedback utterance analysis section which decides to which one of system utterances executed precedingly the user utterance corresponds as a feedback utterance is provided. The user feedback utterance analysis section compares (A) a type of an entity (entity information) included in the user utterance and (B1) types of requested entities corresponding to system utterances in which a system utterance in the past is an entity to be requested to the user, and a system utterance having a requested entity type that matches with the entity type included in the user utterance is determined as a system utterance of a feedback target of the user utterance.

### TECHNICAL FIELD

The present disclosure relates to an information processing apparatus, an information processing system, an information processing method, and a program. More particularly, the present disclosure relates to an information processing apparatus, an information processing system, information processing method, and a program by which processing or response according to a user utterance is executed.

### BACKGROUND ART

These days, use of a voice dialog system that performs voice recognition and performs various processing and response based on a result of the recognition is increasing.

In this voice recognition system, analysis of a user utterance inputted through a microphone is performed and a process according to a result of the analysis is performed.

For example, in the case where the user utters “tell me tomorrow's whether,” the voice dialog system acquires weather information from a weather information providing server, and generates a system response based on the acquired information, and then outputs the generated response from a speaker. In particular, for example, such a system utterance as

system utterance=“tomorrow's weather is supposed to be fine. However, there may be a thunderstorm in the evening.”

is outputted.

In the case where any task (information search or the like) is to be performed on the basis of a user utterance, the system may not be able to execute a process according to an intention of the user only by a single time user utterance of the user.

In order to cause the system to execute a process according to an intention of a user, a plural number of times of dialog with the system such as, for example, rewording is sometimes required.

PTL 1 (Japanese Patent Laid-open No. 2015-225657) discloses a configuration in which, in the case where a user performs user utterance for asking for something (query), a system generates a meaning clarification guidance sentence for clarifying the meaning of the user utterance and outputs this as a system utterance.

Further, the system receives a user response (feedback utterance) to the system utterance as an input thereto and analyzes the substance of the request of the first user utterance accurately.

In PTL 1 specified above, the system is configured such that a user utterance made immediately after a system utterance (meaning clarification guidance sentence) outputted from the system is applied to meaning clarification of the first user utterance.

However, the user does not necessarily listen to an utterance of the other party (system) and tends to rapidly move the conversation forward or transiently change the topic to a different matter in the middle of the conversation. Accordingly, a user utterance made immediately after a system utterance (meaning clarification guidance sentence) is sometimes different from a response of the user to the system utterance (meaning clarification guidance sentence).

For example, there is a case in which the user utterance is an utterance regarding a new different request of the user. Further, the user utterance sometimes is an utterance that is not directed to the system.

In such a case as just described, if the system determines that this user utterance is a response of the user to the system utterance (meaning clarification guidance sentence) and uses the utterance for clarification of the first user utterance, then this conversely gives rise to a problem that the first user utterance is further obscured.

### CITATION LIST

### Patent Literature

### [PTL 1]

Japanese Patent Laid-open No. 2015-225657

### SUMMARY

### Technical Problems

The present disclosure has been made, for example, in view of such a problem as described above, and it is an object of the present disclosure to provide an information processing apparatus, an information processing system, an information processing method, and a program that make it possible for a user and the system to perform smooth and consistent dialog by analyzing each of user utterances emitted at various timings to find to which one of a plurality of system utterances executed previously the user utterance corresponds as a feedback utterance (response utterance).

### Solution to Problems

The first aspect of the present disclosure resides in an information processing apparatus that includes a user feedback utterance analysis section configured to decide whether or not a user utterance is a feedback utterance as a response to a past system utterance (utterance of the information processing apparatus) executed precedingly, in which the user feedback utterance analysis section analyzes a relevance between the user utterance and system utterances in the past to select a system utterance having a high relevance, as a system utterance of a feedback target of the user utterance.

Further, the second aspect of the present disclosure resides in an information processing system including a user terminal, and a data processing server, in which the user terminal includes a sound inputting section for inputting a user utterance, and the data processing server includes a user feedback utterance analysis section that decides whether or not the user utterance received from the user terminal is a feedback utterance as a response to a past system utterance (utterance of the user terminal) executed precedingly, the user feedback utterance analysis section analyzing a relevance between the user utterance and system utterances in the past and selects a system utterance having a high relevance, as a system utterance of a feedback target of the user utterance.

Further, the third aspect of the present disclosure resides in an information processing method that is executed by an information processing apparatus, in which the information processing apparatus includes a user feedback utterance analysis section configured to decide whether or not a user utterance is a feedback utterance as a response to a past system utterance (utterance of the information processing apparatus) in the past executed precedingly, the user feedback utterance analysis section analyzing a relevance between the user utterance and system utterances in the past to select a system utterance having a high relevance, as a system utterance of a feedback target of the user utterance.

Further, the fourth aspect of the present disclosure resides in an information processing method that is executed in an information processing system including a user terminal and a data processing server, in which the user terminal executes a sound inputting process for inputting a user utterance, the data processing server includes a user feedback utterance analysis process for deciding whether or not the user utterance received from the user terminal is a feedback utterance as a response to a past system utterance (utterance of the user terminal) in the past executed precedingly, the user feedback utterance analysis process analyzing a relevance between the user utterance and system utterances in the past and selects a system utterance having a high relevance, as a system utterance of a feedback target of the user utterance.

Furthermore, the fifth aspect of the present disclosure resides in a program for causing an information processing apparatus to execute an information process, in which the information processing apparatus includes a user feedback utterance analysis section configured to decide whether or not a user utterance is a feedback utterance as a response to a past system utterance (utterance of the information processing apparatus) executed precedingly, and the program causes the user feedback utterance analysis section to analyze a relevance between the user utterance and system utterances in the past to select a system utterance having a high relevance, as a system utterance of a feedback target of the user utterance.

It is to be noted that the program of the present disclosure is a program that can be provided, for example, to an information processing apparatus or a computer system that can execute various program codes by a storage medium or a communication medium by which the program is provided in a computer-readable form. By providing such a program as just described in a computer-readable form, processing according to the program is implemented on an information processing apparatus or a computer system.

The above and other objects, features, and advantages of the present disclosure will become apparent from more detailed description based on the working example of the present disclosure hereinafter described and the accompanying drawings. Further, the system in the present specification is a logical aggregation configuration of a plurality of devices and is not limited to a system in which apparatuses of the various configurations are provided in the same housing.

### Advantageous Effects of Invention

With the configuration of the working example of the present disclosure, an apparatus and a method which analyze a user utterance with high accuracy about to which one of a plurality of system utterances performed precedingly the user utterance corresponds as a feedback utterance are implemented.

In particular, for example, a user feedback utterance analysis section which decides to which one of system utterances executed precedingly the user utterance corresponds as a feedback utterance is provided. The user feedback utterance analysis section compares (A) a type of an entity (entity information) included in the user utterance and (B1) types of requested entities corresponding to system utterances in which a system utterance in the past is an entity to be requested to the user, and a system utterance having a requested entity type that matches with the entity type included in the user utterance is determined as a system utterance of a feedback target of the user utterance.

With the present configuration, an apparatus and a method which analyze the user utterance with high accuracy about to which one of a plurality of system utterances performed precedingly the user utterance corresponds as a feedback utterance are implemented.

It is to be noted that the advantageous effects described in the present specification are exemplary to the last and are not restrictive, and additional advantageous effects may be available.

### BRIEF DESCRIPTION OF DRAWINGS

FIG. 1 is a view illustrating an example of an information processing apparatus that performs response and processing based on a user utterance.

FIG. 2 is a view illustrating an example of a configuration and an example of use of the information processing apparatus.

FIG. 3 is a view illustrating an example of a particular configuration of the information processing apparatus.

FIG. 4 is a view illustrating a particular example of processing executed by the information processing apparatus.

FIG. 5 is a view illustrating an example of data applied to a user feedback utterance analysis process.

FIG. 6 is a view illustrating an example of data applied to the user feedback utterance analysis process.

FIG. 7 is a view illustrating a particular example of the user feedback utterance analysis process.

FIG. 8 is a view illustrating another particular example of the user feedback utterance analysis process.

FIG. 9 is a view illustrating a further particular example of the user feedback utterance analysis process.

FIG. 10 is a view illustrating a still further particular example of the user feedback utterance analysis process.

FIG. 11 is a view depicting a flowchart illustrating a sequence of processing executed by the information processing apparatus.

FIG. 12 is a view depicting a flowchart illustrating another sequence of processing executed by the information processing apparatus.

FIG. 13 is a view depicting a flowchart illustrating a further sequence of processing executed by the information processing apparatus.

FIG. 14 is a view depicting an example of a configuration of an information processing system.

FIG. 15 is a view illustrating an example of a hardware configuration of the information processing apparatus.

### DESCRIPTION OF EMBODIMENTS

In the following, details of an information processing apparatus, an information processing system, an information processing method, and a program of the present disclosure are described with reference to the drawings. It is to be noted that the description is given according to the following items.

1. Example of Configuration of Information Processing Apparatus

2. Processing Executed by User Feedback Utterance Analysis Section

3. Other Working Examples

4. Sequence of Processing Executed by Information Processing Apparatus

5. Information Processing Apparatus and Example of Configuration of Information Processing System

6. Example of Hardware Configuration of Information Processing Apparatus

7. Summary of Configuration of Present Disclosure

### 1. Overview of Processing Executed by Information Processing Apparatus

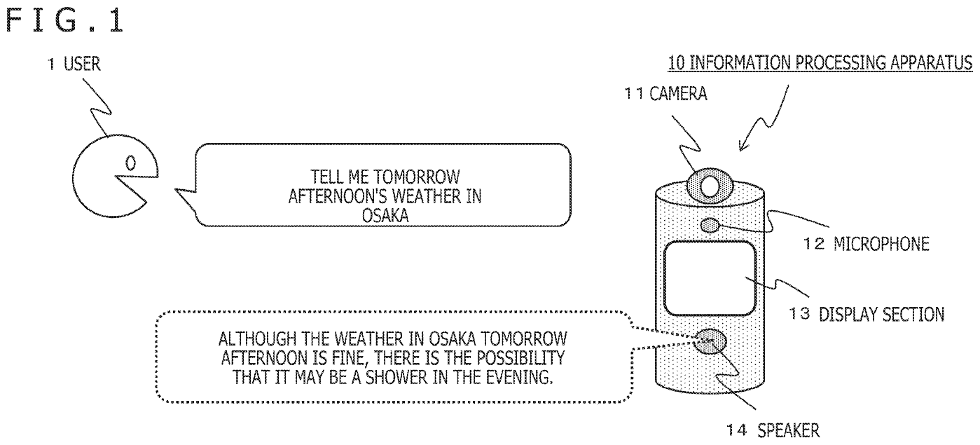

First, an overview of processing executed by the information processing apparatus of the present disclosure is described with reference to FIG. 1 and so forth.

FIG. 1 is a view depicting an example of processing of an information processing apparatus 10 that recognizes a user utterance emitted from a user 1 and performs response to the user utterance.

The information processing apparatus 10 executes a voice recognition process for a user utterance, for example,

user utterance=“tell me the weather in Osaka tomorrow afternoon”

Further, the information processing apparatus 10 executes processing based on a result of the voice recognition of the user utterance.

In the example depicted in FIG. 1, the information processing apparatus 10 acquires data for responding to the user utterance=“tell me the weather in Osaka tomorrow afternoon,” generates a response on the basis of the acquired data, and outputs the generated response through a speaker 14.

In the example depicted in FIG. 1, the information processing apparatus 10 performs the following system response.

System response=“although the weather in Osaka tomorrow afternoon is supposed to be fine, there is the possibility that it may be a shower in the evening.”

The information processing apparatus 10 executes a speech synthesis process (TTS: Text to Speech) to generate the system response described above and outputs the system response.

The information processing apparatus 10 generates a response by using knowledge data acquired from a storage section in the apparatus or knowledge data acquired through a network and outputs the response.

The information processing apparatus 10 depicted in FIG. 1 includes a camera 11, a microphone 12, a display section 13, and the speaker 14 and has a configuration capable of inputting and outputting sound and inputting and outputting an image.

The information processing apparatus 10 depicted in FIG. 1 is called, for example, a smart speaker or an agent device.

It is to be noted that the information processing apparatus 10 may be configured such that a voice recognition process and a meaning analysis process for a user utterance is performed in the information processing apparatus 10 or is executed by a data processing server that is one of servers 20 on the cloud side.

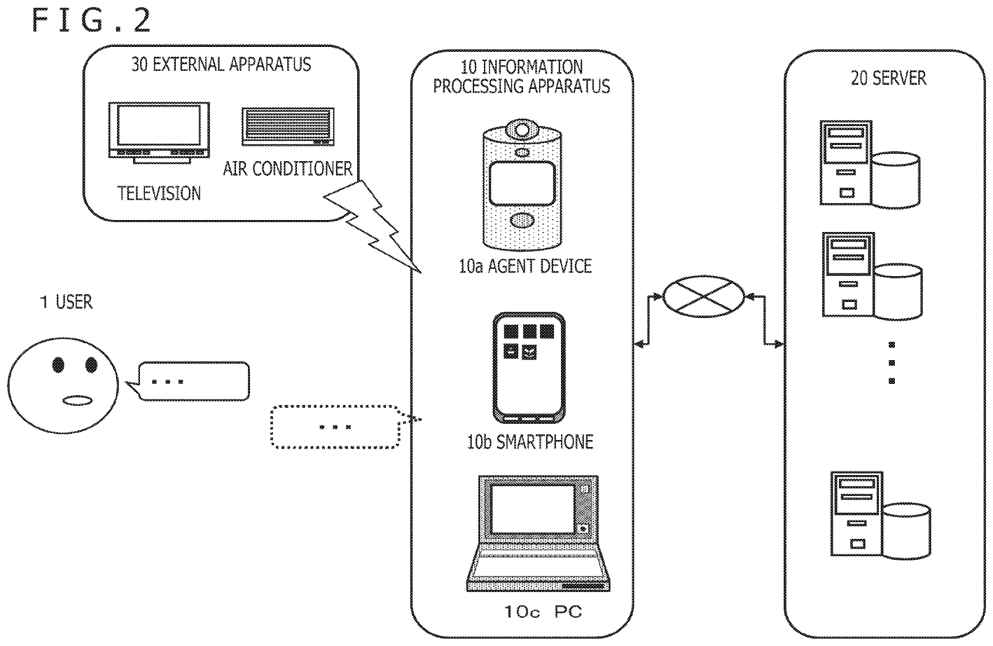

The information processing apparatus 10 of the present disclosure can be configured not only as an agent device 10a but also in various apparatus forms like a smartphone 10b or a PC 10c, as depicted in FIG. 2.

The information processing apparatus 10 not only recognizes an utterance of the user 1 and performs response based on the user utterance but also executes control of an external apparatus 30 such as, for example, a television set or an air conditioner as depicted in FIG. 2 in response to the user utterance.

For example, in the case where the user utterance is such a request as “change the TV channel to 1” or “set the temperature of the air conditioner to 20 degrees,” the information processing apparatus 10 outputs a control signal (Wi-Fi, infrared light or the like) to the external apparatus 30 on the basis of a result of voice recognition of the user utterance to execute control according to the user utterance.

It is to be noted that the information processing apparatus 10 is connected to the server 20 through a network and can acquire information necessitated for generation of a response to a user utterance from the server 20. Furthermore, the information processing apparatus 10 may be configured such that a voice recognition process and a meaning analysis process are performed by a server as described hereinabove.

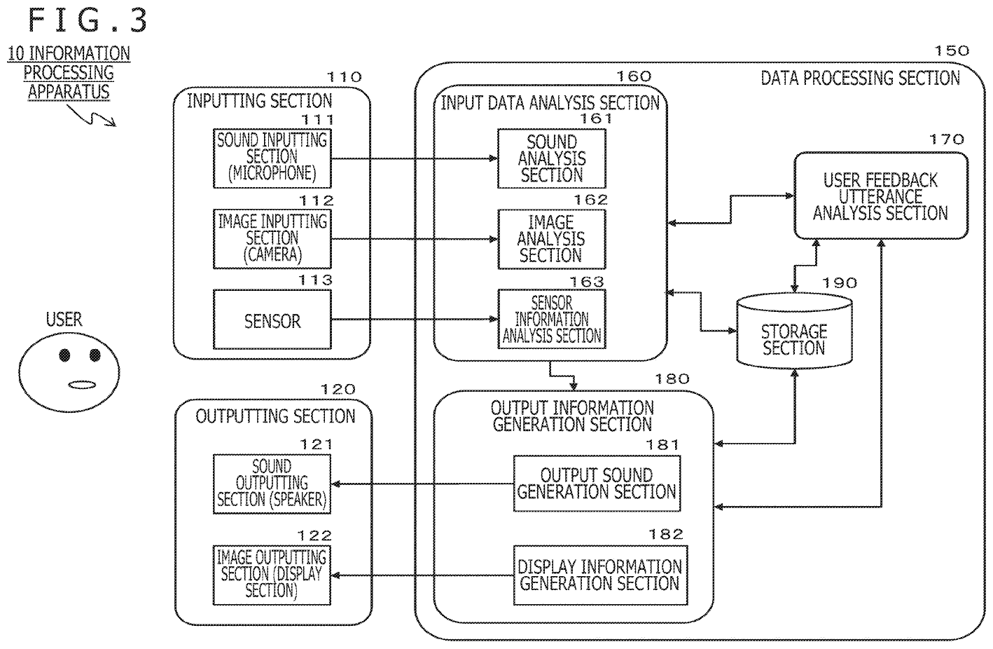

Now, an example of a particular configuration of the information processing apparatus is described with reference to FIG. 3.

FIG. 3 is a view depicting an example of a configuration of the information processing apparatus 10 that performs processing and response corresponding to the user utterance.

As depicted in FIG. 3, the information processing apparatus 10 includes an inputting section 110, an outputting section 120, and a data processing section 150.

It is to be noted that, although it is possible to configure the data processing section 150 in the information processing apparatus 10, the data processing section 150 is not required to be configured in the information processing apparatus 10 and a data processing section of an external server may be utilized. In the case of the configuration that utilizes a server, the information processing apparatus 10 transmits input data inputted thereto from the inputting section 110 to the server through a network and then receives a result of processing of the data processing section 150 of the server to output the result of processing through the outputting section 120.

Now, the components of the information processing apparatus 10 depicted in FIG. 3 are described.

The inputting section 110 includes a sound inputting section (microphone) 111, an image inputting section (camera) 112, and a sensor 113.

The outputting section 120 includes a sound outputting section (speaker) 121 and an image outputting section (display section) 122.

The information processing apparatus 10 includes at least the components mentioned.

It is to be noted that the sound inputting section (microphone) 111 corresponds to the microphone 12 of the information processing apparatus 10 depicted in FIG. 1.

The image inputting section (camera) 112 corresponds to the camera 11 of the information processing apparatus 10 depicted in FIG. 1.

The sound outputting section (speaker) 121 corresponds to the speaker 14 of the information processing apparatus 10 depicted in FIG. 1

The image outputting section (display section) 122 corresponds to the display section 13 of the information processing apparatus 10 depicted in FIG. 1.

It is to be noted that it is also possible to configure the image outputting section (display section) 122, for example, from a projector or the like and it is also possible to configure the image outputting section (display section) 122 utilizing a display section of a television set of an external apparatus.

The data processing section 150 is configured in one of the information processing apparatus 10 or a server that can communicate with the information processing apparatus 10 as described hereinabove.

The data processing section 150 includes an input data analysis section 160, a user feedback utterance analysis section 170, an output information generation section 180, and a storage section 190.

The input data analysis section 160 includes a sound analysis section 161, an image analysis section 162, and a sensor information analysis section 163.

The output information generation section 180 includes an output sound generation section 181 and a display information generation section 182.

Utterance voice of a user is inputted to the sound inputting section 111 such as a microphone.

The sound inputting section (microphone) 111 inputs the inputted user utterance voice to the sound analysis section 161.

The sound analysis section 161 has, for example, an ASR (Automatic Speech Recognition) function and converts voice data into text data including a plurality of words.

Further, the sound analysis section 161 executes an utterance meaning analysis process for the text data.

The sound analysis section 161 has a natural language understanding function such as, for example, NLU (Natural Language Understating) and estimates an intention (intent: Intent) of a user utterance from text data and entity information (entity: Entity) that is significant factors (significant factors) included in the utterance.

A particular example is described. It is assumed that, for example, the following user utterance is inputted.

User utterance=tell me the weather in Osaka tomorrow afternoon

Of this user utterance,

the intention (intent) is that the user want to know the weather, and

the entity information (entity) is the words of Osaka, tomorrow, and afternoon.

If the intention (intent) and the entity information (entity) can be estimated and acquired correctly from the user utterance, then the information processing apparatus 100 can perform accurate processing for the user utterance.

For example, in the example described above, it is possible to acquire the next day afternoon's weather forecast for Osaka and output the weather forecast as a response.

The user utterance analysis information acquired by the sound analysis section 161 is stored into the storage section 190 and is outputted to the user feedback utterance analysis section 170 and the output information generation section 180.

The image inputting section 112 captures an image of the uttering user and surroundings of the uttering user and inputs the image to the image analysis section 162.

The image analysis section 162 performs analysis of the facial expression of the uttering user, and the behavior and gaze information of the user, and surrounding information and so forth of the uttering user. Then, the image analysis section 162 stores a result of the analysis into the storage section 190 and outputs the result of the analysis to the user feedback utterance analysis section 170 and the output information generation section 180.

The sensor 113 is including sensors that acquire data necessary for analyzing, for example, the air temperature, barometric pressure, user gaze, body temperature and so forth. The acquired information of the sensors is inputted to the sensor information analysis section 163.

The sensor information analysis section 163 acquires data of, for example, the air temperature, barometric pressure, user gaze, body temperature and so forth, based on the acquired information of the sensors. Then, the sensor information analysis section 163 stores a result of analysis of the data into the storage section 190 and outputs the result of the analysis to the user feedback utterance analysis section 170 and the output information generation section 180.

The user feedback utterance analysis section 170 receives, as inputs thereto,

a result of analysis by the sound analysis section 161, that is, user utterance analysis information such as an intention (intent: Intent) of a user utterance and entity information (entity: Entity) that is significant factors (significant factors) included in the utterance,

a result of analysis by the image analysis section 162, that is, a facial expression of the uttering user, and the behavior and gaze information of the user, and surrounding information and so forth of the uttering user, and

a result of analysis by the sensor information analysis section 163, that is, data of, for example, the air temperature, barometric pressure, user gaze, body temperature and so forth, and

executes a user feedback utterance analysis process.

The user feedback utterance analysis process executed by the user feedback utterance analysis section 170 is a process of analyzing user utterances emitted at various timings to find to which one of a plurality of system utterances (utterances outputted from the information processing apparatus 10) executed before such user utterances the relevant user utterance corresponds as a feedback utterance (response utterance) and besides to which system utterance the feedback utterance (response utterance) corresponds.

By performing this process, it becomes possible to perform smooth and consistent dialog between the user and the system.

Details of the user feedback utterance analysis process executed by the user feedback utterance analysis section 170 are hereinafter described.

Into the storage section 190, the substance of a user utterance, learning data based on a user utterance, displaying data to be outputted to the image outputting section (display section) 122 and so forth are stored.

Into the storage section 190, user feedback utterance analysis information including data to be applied to the user feedback utterance analysis process executed by the user feedback utterance analysis section 170 such as, for example, dialog history data between the user and the system (information processing apparatus 10) is further stored.

A particular example regarding the information is hereinafter described

The output information generation section 180 includes the output sound generation section 181 and the display information generation section 182.

The output sound generation section 181 generates a system utterance to a user on the basis of user utterance analysis information that is a result of analysis of the sound analysis section 161 and a result of a user feedback utterance analysis process executed by the user feedback utterance analysis section 170.

Response sound information generated by the output sound generation section 181 is outputted through the sound outputting section 121 such as a speaker.

The display information generation section 182 displays text information of a system utterance to a user and other presentation information.

For example, in the case where a user performs user utterance asking the system to show the world map, the display information generation section 182 displays the world map.

The world map can be acquired, for example, from a service providing server.

It is to be noted that the information processing apparatus 10 also has a process execution function for a user utterance.

For example, in the case of such an utterance as

user utterance=reproduce the music, or

user utterance=show me an interesting video,

the information processing apparatus 10 performs a process for the user utterance, that is, a music reproduction process or a video reproduction process.

Though not depicted in FIG. 3, the information processing apparatus 10 has such various process execution functions as described above.

### 2. Process Executed by User Feedback Utterance Analysis Section

Now, details of the user feedback utterance analysis process executed by the user feedback utterance analysis section 170 are described.

As described hereinabove, the user feedback utterance analysis section 170 analyzes each of user utterances emitted at various timings to find to which one of a plurality of system utterances (utterances outputted from the information processing apparatus 10) executed before such user utterances the relevant user utterance corresponds as a feedback utterance (response utterance) and besides to which system utterance the feedback utterance (response utterance) corresponds.

By performing such a process as just described, it becomes possible to perform smooth and consistent dialog between the user and the system.

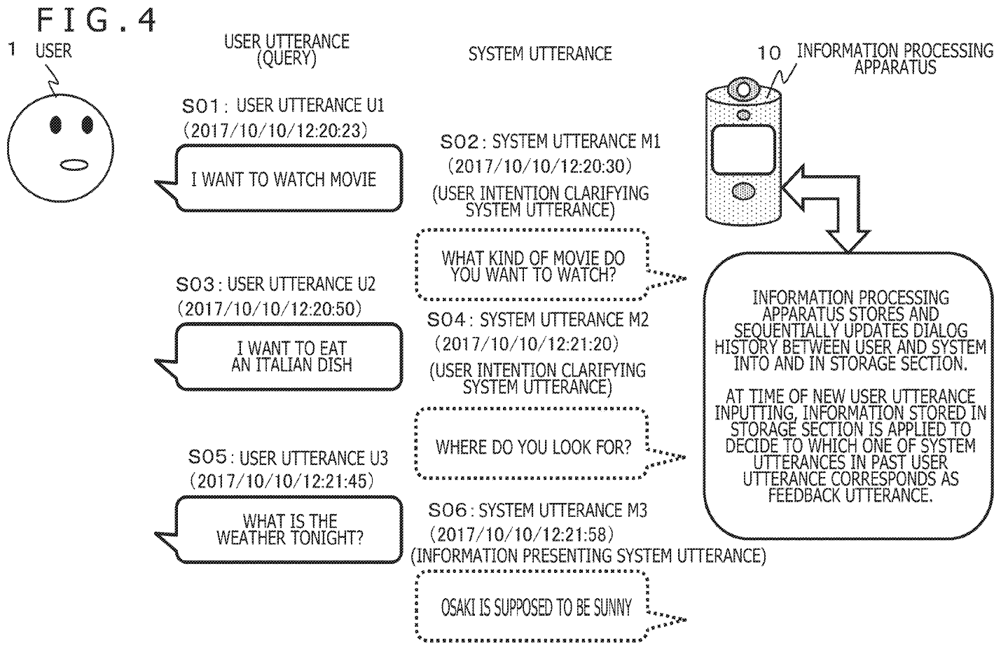

Details of the user feedback utterance analysis process executed by the user feedback utterance analysis section 170 is described with reference to FIG. 4 and so forth.

FIG. 4 depicts an example of a dialog sequence executed between the user 1 and the information processing apparatus 10.

FIG. 4 depicts three user utterances (queries) U1 to U3 and three system utterances M1 to M3.

The utterances are executed in the order of steps S01 to S06 depicted in FIG. 4. The date and time information indicated in each step is execution date and time of the utterance.

The sequence of utterances is indicated in the following.

(Step S01) (2017/10/10/12:20:23)

user utterance U1=I want to watch a movie

(Step S02) (2017/10/10/12:20:30)

system utterance M1=what kind of movie do you want to watch?

(Step S03) (2017/10/10/12:20:50)

user utterance U2=I want to eat an Italian dish

(Step S04) (2017/10/10/12:21:20)

system utterance M2=where do you look for?

(Step S05) (2017/10/10/12:21:45)

user utterance U3=what is the weather tonight?

(Step S06) (2017/10/10/12:21:58)

system utterance M3=Osaki is supposed to be sunny

In the dialogs between the user and the system, for example, the system utterance

system utterance M1 in step S02=what kind of movie do you want to watch?

is a system utterance for confirming a user intention corresponding to the immediately preceding user utterance, that is,

to the question (query) of the user in step S01, that is,

user utterance U1=I want to watch a movie.

Such a system utterance for confirming a user intention as just described is called “user intention clarifying system utterance.”

However, the user 1 does not perform response to,

system utterance M1 in step S02=what kind of movie do you want to watch?

that is, the user intention clarifying system utterance.

It is to be noted that the response to the “user intention clarifying system utterance” is called

“user feedback utterance.”

In the example depicted in FIG. 4, the user 1 does not perform “feedback utterance” to the “user intention clarifying system utterance,”

system utterance M1 in step S02=what kind of movie do you want to watch?

but performs the next different question (query). That is, the user 1 performs the question (query),

user utterance U2 in step S03=I want to eat an Italian dish.

The information processing apparatus 10 (system) outputs, in response to the user utterance (query),

user utterance U2 in step S03=I want to eat an Italian dish,

the “user intention clarifying system utterance,”

system utterance M2 in step S04=where do you look for?

However, the user 1 further performs, without performing a “user feedback utterance” in response to the user intention clarifying system utterance,”

system utterance M2 in step S04=where do you look for?

the following different question (query). That is, the user 1 performs the question (query) of

user utterance U3 in step S05=what is the weather tonight?

The information processing apparatus 10 (system) outputs, in response to the user utterance (query),

user utterance U3 in step S05=what is the weather tonight?

the “information presenting system utterance,”

system utterance M3 in step S06=Osaki is supposed to be sunny.

It is to be noted that the system utterance

system utterance M3 in step S06=Osaki is supposed to be sunny

is not a system utterance for confirming the intention of the user utterance (U3) but is an utterance for performing information presentation as a reply to the user utterance (U3) whose intention has been confirmed.

Such a system utterance as just described is called “information presenting system utterance.”

In the dialog sequence depicted in FIG. 4, for example,

the “user feedback utterance” to the “user intention clarifying system utterance” of

system utterance M1 in step S02=what kind of movie do you want to watch?

is not executed.

Also, the “user feedback utterance” to the “user intention clarifying system utterance” of

system utterance M2 in step S04=Where do you look for?

is not executed.

In such manner, the user may not necessarily perform feedback utterance as a response to the “user intention clarifying system utterance” that is a system utterance executed by the information processing apparatus 10, immediately after the system utterance.

It sometimes occurs that, after the series of dialog sequence (steps S01 to S06) depicted in FIG. 4 comes to an end, a feedback utterance as a response to the “user intention clarifying system utterance” executed previously is suddenly issued as spurts.

The user feedback utterance analysis section 170 of the information processing apparatus 10 of the present disclosure analyzes each of user utterances emitted at various timings in this manner about to which one of a plurality of system utterances (utterances outputted from the information processing apparatus 10) executed before that the feedback utterance (response utterance) corresponds.

By performing this process, it becomes possible to perform smooth and consistent dialog between the user and the system.

As described on the right side in FIG. 4, the information processing apparatus 10 stores a dialog history and so forth between the user and the system (information processing apparatus) as user feedback utterance analyzing information into the storage section 190 and sequentially updates the user feedback utterance analyzing information.

Further, at the time of inputting a new user utterance, the information processing apparatus 10 applies the storage information to decide to which one of the system utterances in the past the new user utterance corresponds as a feedback utterance.

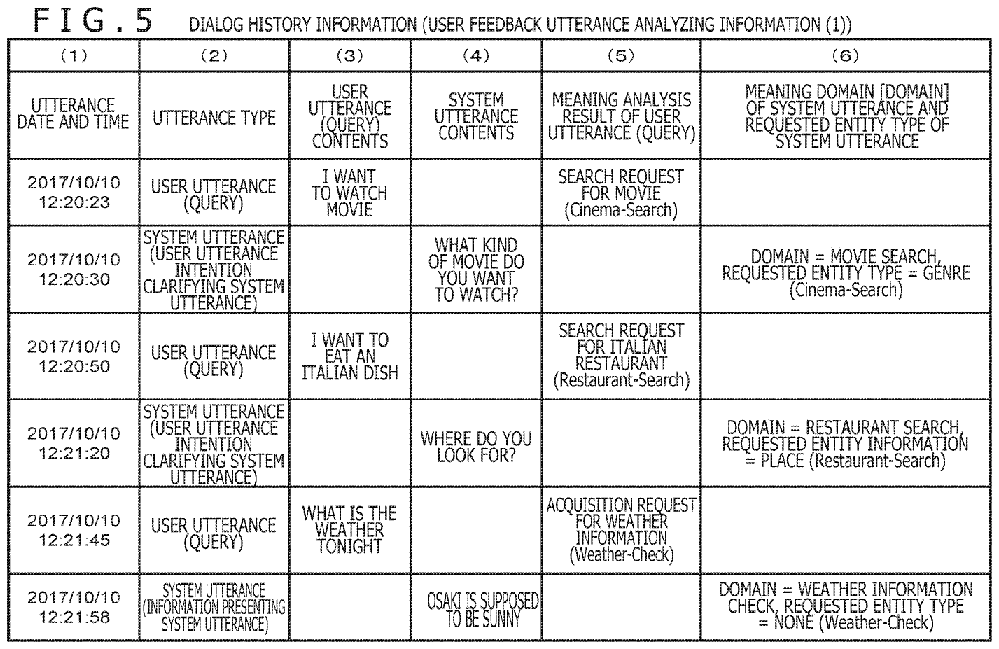

An example of the dialog history information (user feedback utterance analyzing information (1)) stored in the storage section 190 is depicted in FIG. 5.

The dialog history information (user feedback utterance analyzing information (1)) depicted in FIG. 5 corresponds to the dialog history information of the dialog between the user and the system (information processing apparatus) described hereinabove with reference to FIG. 4.

The dialog history information (user feedback utterance analyzing information (1)) depicted in FIG. 5 has the following items of information recorded in an associated relation with each other therein.

(1) Utterance date and time

(2) Utterance type

(3) User utterance contents

(4) System utterance contents

(5) Meaning analysis result of user utterance

(6) Meaning domain [domain] of system utterance and requested entity type of system utterance

In the (1) utterance date and time, execution date and time information of a user utterance or a system utterance is recorded.

In the (2) utterance type, whether the utterance is a user utterance or a system utterance is recorded, and in the case of a user utterance, a type of the user utterance such as whether the user utterance is a query (question) or a process asking request is recorded, but in the case of a system utterance, type information of the system utterance such as a “user intention clarifying system utterance” or an “information presenting system utterance,” is recorded.

In the (3) user utterance contents, text information of the user utterance is recorded.

In the (4) system utterance contents, text information of the system utterance is recorded.

In the (5) meaning analysis result of user utterance, a meaning analysis result of the user utterance is recorded.

In the (6) meaning domain [domain] of system utterance and requested entity type of system utterance, a meaning domain [domain] of the system utterance and a requested entity type of the system utterance are recorded.

The meaning domain [domain] of the system utterance is

a meaning domain the executed system utterance has and is a meaning domain indicative of a processing object in the dialog between the user and the system.

For example, in the case of the system utterance

system utterance=what kind of movie do you want to watch?

executed in response to the user utterance,

user utterance=I want to watch a movie,

it is the meaning domain [domain] of the system utterance=movie search.

Further, in the case of the system utterance,

system utterance=where do you look for?

executed in response to the user utterance,

user utterance=I want to eat an Italian dish,

it is the meaning domain [domain] of the system utterance=restaurant search.

Further, in the case of the system utterance,

system utterance=Osaki is supposed to be sunny

executed in response to the user utterance,

user utterance=what is the weather tonight?

it is the meaning domain [domain] of the system utterance=weather information check.

In this manner, the meaning domain (domain) of a system utterance is a meaning domain indicative of a processing object in the dialog between the user and the system.

The requested entity type of the system utterance is a type of the entity (entity information) which the user is requested by the system utterance.

For example, in the case of the type of the entity (entity information) which the user is requested by the system utterance,

system utterance=what kind of movie do you want to watch?

executed in response to the user utterance,

user utterance=I want to watch a movie,

it is the requested entity type=genre (movie genre).

Further, in the case of the type of the entity (entity information) which the user is requested by the system utterance,

system utterance=where do you look for?

executed in response to the user utterance,

user utterance=I want to eat an Italian dish,

it is the requested entity type=place (place of the restaurant).

It is to be noted that the entity (entity information) which the user is requested by the system utterance

system utterance=Osaki is supposed to be sunny

executed in response to the user utterance,

user utterance=what is the weather tonight?

is not set specifically.

In this case, it is the requested entity type of this system utterance=none.

In this manner, in the (6) meaning domain [domain] of system utterance and requested entity type of system utterance, a meaning domain [domain] of the system utterance and a requested entity type of the system utterance are recorded.

In this manner, in the storage section 190 of the information processing apparatus 10 of the present disclosure, as user feedback utterance analyzing information (1), the dialog history information depicted in FIG. 5 is recorded and is sequentially updated every time user utterance or system utterance is executed.

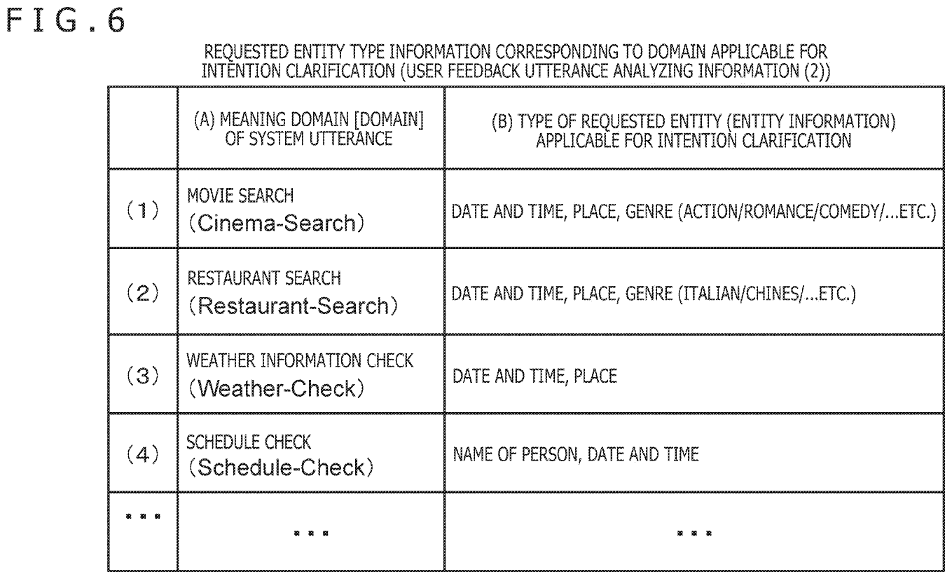

Further, in the storage section 190, information depicted in FIG. 6 is stored as user feedback utterance analyzing information (2).

In particular, information, that is,

“requested entity type information corresponding to a domain applicable for intention clarification”

depicted in FIG. 6 is stored in advance in the storage section 190.

The “requested entity type information corresponding to a domain applicable for intention clarification” is configured as a table that associates data of (A) and (B) with each other,

(A) meaning domain (domain) of a system utterance and

(B) type of a requested entity (entity information) applicable to intention clarification

as depicted in FIG. 6.

For example, as

the (B) type of a requested entity (entity information) applicable to intention clarification

corresponding to the domain,

the (A) meaning domain (domain) of a system utterance=search for a movie theater,

date and time, a place, a genre (action/romance/comedy/ . . . ) and so forth are available.

The (B) type of a requested entity (entity information) applicable to intention clarification is a type of an entity (entity information) capable of being requested to the user in a system utterance to be executed in order to clarify the intention of the user utterance.

For example, as described hereinabove, the meaning domain (domain) of the system utterance

system utterance=what kind of movie do you want to watch?

executed for the user utterance,

user utterance=I want to watch a movie

is

the meaning domain (domain) of the system utterance=movie search.

Further, the type of the entity (entity information) requested to the user by the system utterance is

requested entity type=genre (movie genre).

In this meaning domain (domain) of the system utterance=movie search,

as the type of the entity (entity information) that can be requested to the user, not only the genre described above but also date and time, place and so forth are available as indicated by the entry (1) of the table of FIG. 6.

In this manner, the table depicted in FIG. 6, that is,

“requested entity type information corresponding to a domain applicable to intention clarification” is a table in which

(B) the type of a requested entity (entity information” applicable to intention clarification

(A) in a unit of a meaning domain (domain) of a system utterance

is recorded.

This table is stored in the storage section 190 in advance.

The user feedback utterance analysis section 170 executes analysis of a user utterance referring to information including

the “dialog history information” (user feedback utterance analyzing information (1)) depicted in FIG. 5, and

the “requested entity type information corresponding to a domain applicable for intention clarification” (user feedback utterance analyzing information (2)).

In particular, the user feedback utterance analysis section 170 analyzes each of user utterances emitted at various timings to find to which one of a plurality of system utterances (utterances outputted from the information processing apparatus 10) executed before that the user utterance corresponds as a feedback utterance (response utterance) and besides to which system utterance the user utterance corresponds as a feedback utterance (response utterance).

It is to be noted that, in regard to a result of meaning analysis of (3) user utterance contents and (5) meaning analysis result of user utterance of the dialog history information depicted in FIG. 5, the user feedback utterance analysis section 170 receives, as inputs thereto, results of the sound recognition process and the meaning analysis process for the user utterance executed by the sound analysis section 161 and stores the results into the storage section 190.

Meanwhile, in regard to information of (1) utterance date and time, (2) utterance type, (4) system utterance contents, and (6) meaning domain (domain) of system utterance and requested entity type of system utterance, the user feedback utterance analysis section 170 acquires analysis information of the input data analysis section 160 of the information processing apparatus 10, output information of the output information generation section 180, time information acquired from a time counting section (clock) in the inside of the information processing apparatus 10 or through a network, and other information and stores the acquired information into the storage section 190.

In this manner, the information processing apparatus 10 stores a dialog history and so forth of the user and the system (information processing apparatus) as user feedback utterance analysis information into the storage section 190 and sequentially updates the user feedback utterance analysis information every time a user utterance or system utterance is executed.

Further, the information processing apparatus 10 applies, at the time of inputting of a new user utterance, the information stored in the storage section, that is,

the “dialog history information” (user feedback utterance analyzing information (1)) depicted in FIG. 5, and

the “requested entity type information corresponding to a domain applicable for intention clarification” (user feedback utterance analyzing information (2)) depicted in FIG. 6,

to decide to which system utterance in the past the user utterance corresponds as a feedback utterance.

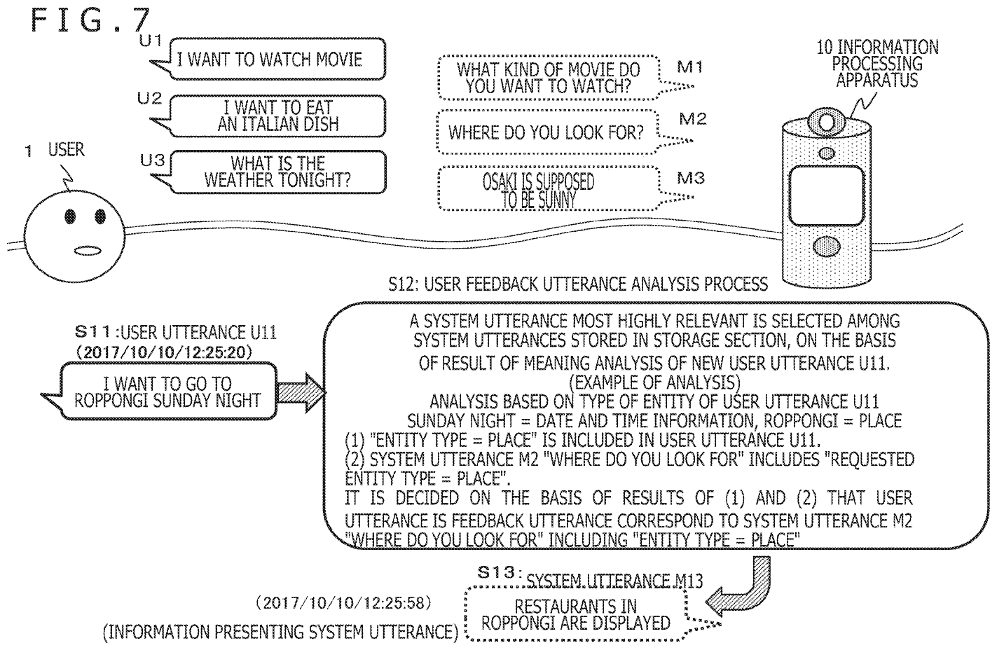

A particular example of the user feedback utterance analysis process executed by the user feedback utterance analysis section 170 is described with reference to FIG. 7.

In the upper stage of FIG. 7, the dialog sequence between the user and the system described hereinabove with reference to FIG. 4 is depicted.

A dialog history corresponding to the dialog sequence is stored as user feedback utterance analysis information in the storage section 190.

In the lower stage of FIG. 7, a subsequent user utterance U11 after this is depicted.

(Step S11) (2017/10/10/12:25:20)

user utterance U11=I want to go to Roppongi Sunday night

The user feedback utterance analysis section 170 of the information processing apparatus 10 analyzes this newly inputted user utterance about whether the user utterance is a feedback utterance corresponding to a system utterance in the past and further to which system utterance the feedback utterance corresponds.

The process executed by the user feedback utterance analysis section 170 of the information processing apparatus 10 is a user feedback utterance analysis process in step S12 depicted in FIG. 7. In particular, the information processing apparatus 10 executes the following processes.

The user feedback utterance analysis section 170 of the information processing apparatus 10 selects a system utterance most highly relevant among the system utterances stored in the storage section 190, on the basis of a result of meaning analysis of the new user utterance U11.

For example, the user feedback utterance analysis section 170 of the information processing apparatus 10 performs analysis based on the type of an entity (entity information) acquired from the result of the utterance meaning analysis of the user utterance U11.

In particular, the following analyzes are performed.

(Analysis 1) The type of the entity included in the user utterance is analyzed.

(Analysis 2) The type of a requested entity of the system utterance is confirmed.

First, the user feedback utterance analysis section 170 of the information processing apparatus 10 confirms, according to the analysis 1, that is,

(analysis 1) analysis of the type of the entity included in the user utterance,

that “entity type=place” is included in the user utterance U11.

In the user utterance,

user utterance U11=I want to go to Roppongi Sunday night,

“Sunday night” and “Roppongi” are included as the entities (entity information).

The types (categories) of the entities are set in the following manner.

Entity type of the entity “Sunday night”=date and time

Entity type of the entity “Roppongi”=place

In this manner, the user feedback utterance analysis section 170 first confirms that “entity type=place” is included in the user utterance U11.

Then,

(analysis 2) confirmation of the type of a requested entity of the system utterance is executed.

This process is executed applying the dialog history information (user feedback utterance analyzing information (1)) described hereinabove with reference to FIG. 5.

In the system utterance M1=“what kind of movie do you want to watch,” the “requested entity type=genre” is included.

In the system utterance M2=“where do you look for,” the “requested entity type=place” is included.

In the system utterance M3=“Osaki is supposed to be sunny,” no requested entity is included because “requested entity type=none.”

The user feedback utterance analysis section 170 searches for a system utterance having “requested entity information” matching “entity type=place” included in the new user utterance U11=“I want to go to Roppongi Sunday night.”

The system utterance in which “requested entity type=place” is the system utterance M2, that is,

system utterance M2=“where do you look for”

The user feedback utterance analysis section 170 decides on the basis of the result of the analysis that the user utterance U11

user utterance U11=“I want to go to Roppongi Sunday night,”

is a feedback utterance corresponding to the system utterance M2 “where do you look for” that inquires about a place.

It is to be noted that, in the present example,

system utterances executed preceding to the user utterance U11, that is,

user utterance U11=I want to go to Roppongi Sunday night

are the three system utterances of

system utterance M1=what kind of movie do you want to watch?

system utterance M2=where do you look for?

system utterance M3=Osaki is supposed to be sunny.

The user feedback utterance analysis section 170 first selects the three system utterances just mentioned, as

system utterance candidates for a feedback (response) target of the user feedback utterance,

user utterance U11=I want to go to Roppongi Sunday night.

It is to be noted that it is specified in advance within which range system utterances in the past are to be set as an analysis target.

For example, such setting is performed that only system utterances executed for the specified time period=one minute before inputting of a new user utterance are set as an analysis target.

The user feedback utterance analysis section 170 analyzes that “entity type=place” is included in the user utterance U11 and decides on the basis of the result of the analysis that the system utterance M2 “where do you look for” inquiring about a place is a system utterance that is a feedback target (response target) of the user utterance,

user utterance U11=I want to go to Roppongi Sunday night.

The user feedback utterance analysis section 170 outputs this result to the output information generation section 180.

The output information generation section 180 generates and outputs the following system utterance M13 in step S13 depicted in FIG. 7, on the basis of the analysis result,

(Step S13) (2017/10/10/12:25:58)

system utterance M13=restaurants in Roppongi are displayed.

If the user feedback utterance (U11) in step S11 and the subsequent system utterance (M13) after this are arranged in a chronological order together with the system utterance (M2) of a feedback target in the past and the user utterance (U2) made immediately preceding to the system utterance (M2), then it becomes as follows.

(Step S03) (2017/10/10/12:20:50)

user utterance U2=I want to eat an Italian dish

(Step S04) (2017/10/10/12:21:20)

system utterance M2=Where do you look for?

(Step S11) (2017/10/10/12:25:20)

user utterance U11=I want to go to Roppongi Sunday night

(Step S13) (2017/10/10/12:25:58)

system utterance M13=Restaurants in Roppongi is displayed.

The dialog sequence described above is a dialog sequence in which the system (information processing apparatus 10) accurately understands intentions of the user utterances, and a smooth and consistent dialog is implemented between the user and the system.

This arises from the analysis result that the user utterance

user utterance U11=I want to go to Roppongi Sunday night

is a feedback utterance (response utterance) to the system utterance

system utterance M2=where do you look for?

performed in the past but not immediately before the user utterance is applied.

In this manner, the user feedback utterance analysis section 170 of the information processing apparatus 10 of the present disclosure analyzes the user utterance about whether or not, even in the case where a feedback utterance (response utterance) from a user to a system utterance is not performed immediately after the system utterance, to which one of system utterances in the past the user utterance corresponds as a feedback utterance (response utterance) by using a result of meaning analysis of the user utterance.

Further, the output information generation section 180 of the information processing apparatus 10 generates and outputs a system utterance based on a result of the analysis.

As a result, the information processing apparatus 10 can perform dialog with an intention of the user utterance understood accurately.

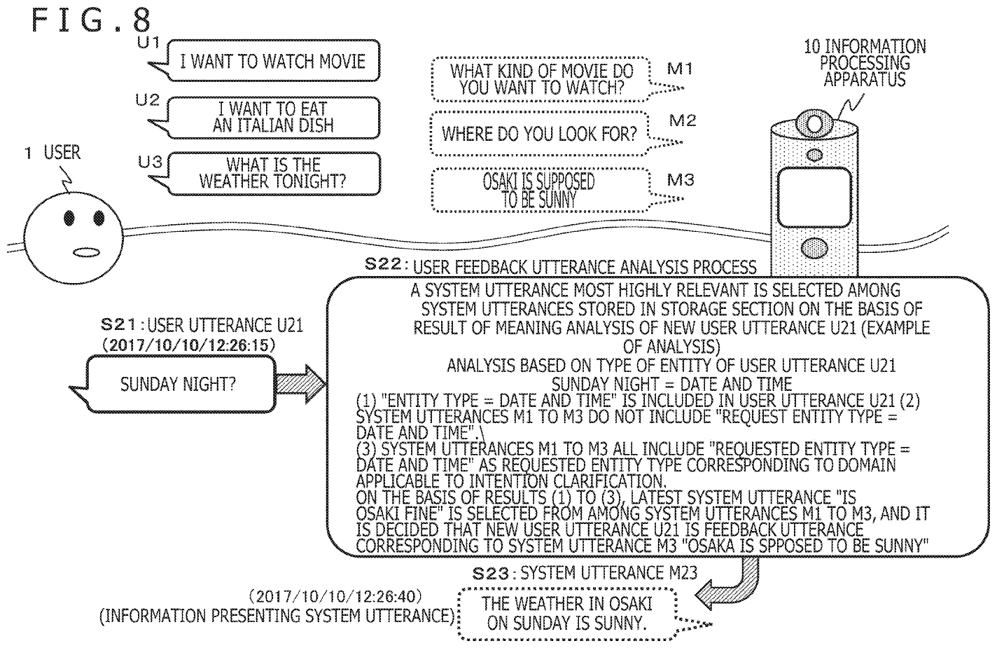

Another particular example of the user feedback utterance analysis process executed by the user feedback utterance analysis section 170 is described with reference to FIG. 8.

In the upper stage of FIG. 8, the dialog sequence between the user and the system described hereinabove with reference to FIG. 4 is depicted.

A dialog history corresponding to the dialog sequence is stored as user feedback utterance analysis information in the storage section 190.

In the lower stage of FIG. 8, a subsequent utterance U21 after that is depicted.

(Step S21) (2017/10/10/12:26:15)

user utterance U21=Sunday night?

The user feedback utterance analysis section 170 of the information processing apparatus 10 analyzes this newly inputted user utterance about whether or not the user utterance is a feedback utterance corresponding to a system utterance in the past and further to which system utterance the feedback utterance corresponds.

The process executed by the user feedback utterance analysis section 170 of the information processing apparatus 10 is the user feedback utterance analysis process in step S22 depicted in FIG. 8. That is, the information processing apparatus 10 executes the following processes.

The user feedback utterance analysis section 170 of the information processing apparatus 10 selects a system utterance most highly relevant among the system utterances stored in the storage section 190, on the basis of a result of meaning analysis of the new user utterance U21.

For example, the user feedback utterance analysis section 170 of the information processing apparatus 10 performs analysis based on the type of an entity (entity information) acquired from the result of the utterance meaning analysis of the user utterance U21.

In particular, the following analyzes are performed.

(Analysis 1) The type of the entity included in the user utterance is analyzed.

(Analysis 2) The type of a requested entity of the system utterance is confirmed.

(Analysis 3) The type of the requested entity applicable to intention clarification corresponding to a domain of the system utterance is confirmed.

First, the user feedback utterance analysis section 170 of the information processing apparatus 10 confirms that “entity type=date and time” is included in the user utterance U21 according to the analysis 1,

(analysis 1) analysis of the type of the entity included in the user utterance.

In the user utterance,

user utterance U21=Sunday night?

“Sunday night” is included as the entity (entity information).

The type (category) of the entity is set in the following manner.

Entity type of entity “Sunday night”=date and time

In this manner, the user feedback utterance analysis section 170 first confirms that “entity type=date and time” is included in the user utterance U21.

Then,

(analysis 2) confirmation of the type of a requested entity of the system utterance is executed.

This process is executed by applying the dialog history information (user feedback utterance analyzing information (1)) described hereinabove with reference to FIG. 5.

In the system utterance M1=“what kind of movie do you want to watch,” “requested entity type=genre” is included.

In the system utterance M2=“where do you look for,” “requested entity type=place” is included.

In the system utterance M3=“Osaki is supposed to be sunny,” no requested entity is included because “requested entity type=none.”

The user feedback utterance analysis section 170 searches for a system utterance having “requested entity type” coincident with “entity type=date and time” included in the new user utterance U21=“Sunday night?”

A system utterance in which requested entity type=date and time” does not exist

in the system utterances M1 to M3.

In this case, the user feedback utterance analysis section 170 subsequently confirms (analysis 3) the type of the requested entity applicable to intention clarification corresponding to a domain of the system utterance.

This process is executed by applying the “requested entity type information corresponding to a domain applicable for intention clarification” (user feedback utterance analyzing information (2)) described hereinabove with reference to FIG. 6.

The system utterance M1=“what kind of movie do you want to watch?” (domain=movie search) includes the “requested entity type information corresponding to a domain applicable for intention clarification=date and time, place, genre.”

The system utterance M2=“where do you look for” (domain=restaurant search) includes “requested entity type information corresponding to a domain applicable for intention clarification=date and time, place, genre.”

The system utterance M3=“Osaki is supposed to be sunny” (domain=weather information check) includes “requested entity type information corresponding to a domain applicable for intention clarification=date and time, place.”

The user feedback utterance analysis section 170 searches for a system utterance having “requested entity type information corresponding to a domain applicable for intention clarification” coincident with the “entity type=date and time” included in the user utterance U21=“Sunday night?”

In the case of the present example, all of the system utterances M1 to M3 include

the “requested entity type corresponding to a domain applicable for intention clarification=date and time.”

In other words, all of the system utterances M1 to M3 are system utterances that allow system responses that restrict date and time.

In this case, the user feedback utterance analysis section 170 selects the latest system utterance from among the system utterances M1 to M3 in which

the “requested entity type corresponding to a domain applicable for intention clarification=date and time”

is included.

In particular, the latest system utterance M3=“is Osaki sunny?” is selected, and it is decided that the new user utterance U21 is a feedback utterance corresponding to the system utterance M3 “is Osaki sunny?”

It is to be noted that

system utterances executed before the user utterance U21

user utterance U21=Sunday night?

are three system utterances as follows.

system utterance M1=what kind of movie do you want to watch?

system utterance M2=where do you look for?

system utterance M3=Osaki is supposed to be sunny

The user feedback utterance analysis section 170 first selects the three system utterances as system utterance candidates for a feedback (response) target of the feedback utterance.

user utterance U21=Sunday night?

The user feedback utterance analysis section 170 analyzes that “entity type=date and time” is included in the user utterance U21.

System utterances in the past that allow a system response with the date and time restricted are all of the three system utterances of the above system utterances,

system utterance M1=what kind of movie do you want to watch?

system utterance M2=where do you look for?

system utterance M3=Osaki is supposed to be sunny.

In such a case as just described, the user feedback utterance analysis section 170 selects the newest system utterance “is Osaki sunny?” from among the selected system utterances M1 to M3.

In particular, the user feedback utterance analysis section 170 decides that the user utterance

user utterance U21=Sunday night?

is a feedback utterance corresponding to the system utterance

system utterance M3 “is Osaki sunny?”

The user feedback utterance analysis section 170 outputs this result to the output information generation section 180.

The output information generation section 180 generates and outputs the following system utterance M23 in step S23 depicted in FIG. 8, on the basis of the analysis result.

(step S23) (2017/10/10/12:26:40)

system utterance M23=the weather in Osaki on Sunday is sunny.

If the user feedback utterance (U21) in step S21 and the system utterance (M23) after this are arranged in a chronological order together with the system utterance (M3) of a feedback target in the past and the user utterance (U3) made immediately preceding to the system utterance (M3), then it becomes as follows.

(Step S05) (2017/10/10/12:21:45)

user utterance U3=what is the weather tonight?

(Step S06) (2017/10/10/12:21:58)

system utterance M3=Osaki is supposed to be sunny

(Step S21) (2017/10/10/12:26:15)

user utterance U21=Sunday night?

(Step S23) (2017/10/10/12:26:40)

system utterance M23=the weather in Osaki on Sunday is sunny.

The dialog sequence described above is a dialog sequence in which the system (information processing apparatus 10) accurately understands intentions of the user utterances, and a smooth and consistent dialog is implemented between the user and the system.

This arises from the analysis result that the user utterance

user utterance U21=Sunday night?

is a feedback utterance (response utterance) to the system utterance

system utterance M3=Osaki is supposed to be sunny

performed in the past but not immediately before the user utterance.

In this manner, the user feedback utterance analysis section 170 of the information processing apparatus 10 of the present disclosure analyzes, even in the case where a feedback utterance (response utterance) from the user to a system utterance is not performed immediately after the system utterance, the user utterance about to which one of system utterances in the past the user utterance corresponds as a feedback utterance (response utterance) utilizing a result of meaning analysis of the user utterance.

Further, the output information generation section 180 of the information processing apparatus 10 generates and outputs a system utterance based on a result of the analysis.

As a result, the information processing apparatus 10 can perform dialog with an intention of the user utterance understood accurately.

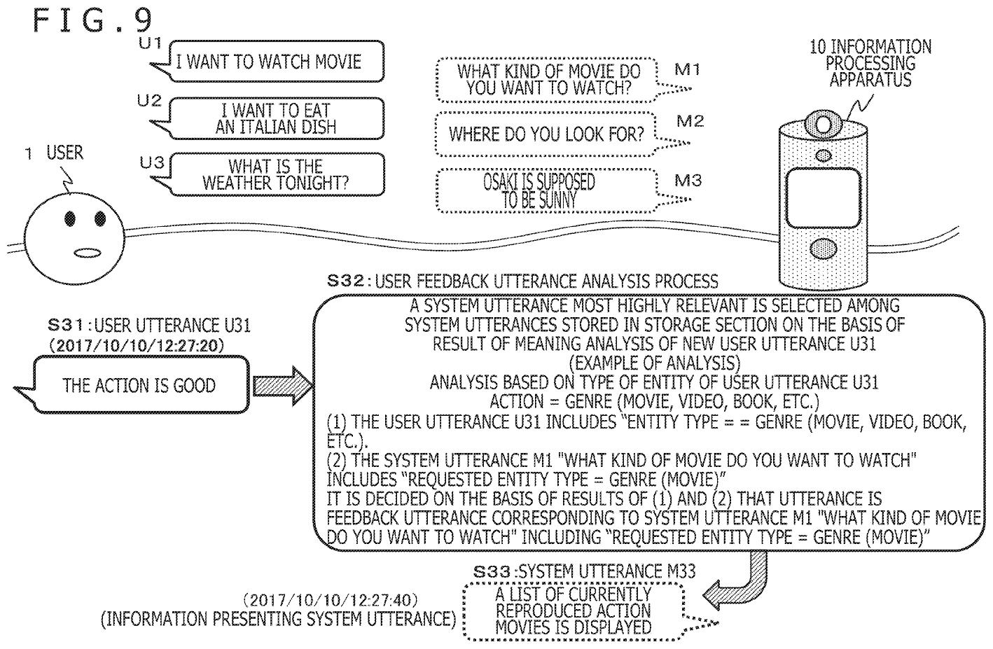

Another particular example of the user feedback utterance analysis process executed by the user feedback utterance analysis section 170 is described with reference to FIG. 9.

In an upper stage of FIG. 9, the dialog sequence between the user and the system described hereinabove with reference to FIG. 4 is depicted.

A dialog history corresponding to the dialog sequence is stored as user feedback utterance analysis information in the storage section 190.

In the lower stage of FIG. 9, a user utterance U31 after that is depicted.

(Step S31) (2017/10/10/12:27:20)

user utterance U31=the action is good

The user feedback utterance analysis section 170 of the information processing apparatus 10 analyzes this newly inputted user utterance about whether or not the user utterance is a feedback utterance corresponding to a system utterance in the past and further to which system utterance the feedback utterance corresponds.

The process executed by the user feedback utterance analysis section 170 of the information processing apparatus 10 is the user feedback utterance analysis process in step S32 depicted in FIG. 9. That is, the user feedback utterance analysis section 170 executes the following processes.

The user feedback utterance analysis section 170 of the information processing apparatus 10 selects a system utterance most highly relevant among the system utterances stored in the storage section 190, on the basis of a result of meaning analysis of the new user utterance U31.

For example, the user feedback utterance analysis section 170 of the information processing apparatus 10 performs analysis based on the type of an entity (entity information) acquired from the result of the utterance meaning analysis of the user utterance U31.

In particular, the following analyzes are performed.

(Analysis 1) The type of the entity included in the user utterance is analyzed.

(Analysis 2) The type of a requested entity of the system utterance is confirmed.

First, the user feedback utterance analysis section 170 of the information processing apparatus 10 confirms that “entity type=genre” is included in the user utterance U31 according to the analysis 1,

(analysis 1) analysis of the type of the entity included in the user utterance.

In the user utterance,

user utterance U31=the action is good

“action” is included as the entity (entity information).

The type (category) of the entity is set in the following manner,

entity type of entity “action”=genre (movie, video, book or the like).

In this manner, the user feedback utterance analysis section 170 first confirms that “entity type=genre” is included in the user utterance U31.

Then,

(analysis 2) confirmation of the type of a requested entity of the system utterance is executed.

This process is executed by applying the dialog history information (user feedback utterance analyzing information (1)) described hereinabove with reference to FIG. 5.

In the system utterance M1=“what kind of movie do you want to watch,” “requested entity type=genre” is included.

In the system utterance M2=“where do you look for,” “requested entity type=place” is included.

In the system utterance M3=“Osaki is supposed to be sunny,” no requested entity is included because “requested entity type=none.”

The user feedback utterance analysis section 170 searches for a system utterance having “requested entity type” coincident with “entity type=genre” included in the new user utterance U31=“the action is good.”

A system utterance in which “requested entity type=genre” is included is the system utterance M1,

system utterance M1=what kind of movie do you want to watch?

The user feedback utterance analysis section 170 decides, on the basis of this analysis result, that the user utterance U31

user utterance U31=“the action is good”

is a feedback utterance corresponding to the system utterance M1 “what kind of movie do you want to watch?” that inquires about a genre.

It is to be noted that system utterances executed before the user utterance U31

user utterance U31=the action is good

are three system utterances of

system utterance M1=what kind of movie do you want to watch?

system utterance M2=where do you look for?

system utterance M3=Osaki is supposed to be sunny.

The user feedback utterance analysis section 170 first selects the three system utterances as system utterance candidates for a feedback (response) target of the feedback utterance,

user utterance U31=the action is good.

The user feedback utterance analysis section 170 analyzes that “entity type=genre (movie, video, book or the like” is included in the user utterance U31.

The user feedback utterance analysis section 170 decides, on the basis of this analysis result, that system utterance M1 “what kind of movie do you want to watch?” inquiring a movie genre

is a system utterance that is a feedback target (response target) of the user utterance

user utterance U31=the action is good.

The user feedback utterance analysis section 170 outputs this result to the output information generation section 180.

The output information generation section 180 generates the following system utterance M33 in step S33 depicted in FIG. 9, on the basis of the analysis result and outputs the system utterance M33.

(Step S33) (2017/10/10/12:27:40)

system utterance M33=a list of action movies that are currently being reproduced is displayed.

Further, the output information generation section 180 performs a process for displaying the action movie list on the image outputting section (display section) 122.

If the user feedback utterance (U31) in step S31 and the system utterance (M33) after this are arranged in a chronological order together with the system utterance (M1) of a feedback target in the past and the user utterance (U1) made immediately preceding to the system utterance (M1), then it becomes as follows.

(Step S01) (2017/10/10/12:20:23)

user utterance U1=I want to watch a movie

(Step S02) (2017/10/10/12:20:30)

system utterance M1=what kind of movie do you want to watch?

(Step S31) (2017/10/10/12:27:20)

user utterance U31=the action is good

(Step S33) (2017/10/10/12:27:40)

system utterance M33=a list of action movies that are being currently reproduced is displayed.

The dialog sequence described above is a dialog sequence in which the system (information processing apparatus 10) accurately understands intentions of the user utterances, and a smooth and consistent dialog is implemented between the user and the system.

This arises from the analysis result that the user utterance

user utterance U31=the action is good

is a feedback utterance (response utterance) to the system utterance

system utterance M1=what kind of movie do you want to watch?

performed in the past but not immediately before the user utterance.

In this manner, the user feedback utterance analysis section 170 of the information processing apparatus 10 of the present disclosure analyzes, even in the case where a feedback utterance (response utterance) from a user to a system utterance is not performed immediately after the system utterance, the user utterance about to which one of system utterances in the past the user utterance corresponds as a feedback utterance (response utterance) utilizing a result of meaning analysis of the user utterance.

Further, the output information generation section 180 of the information processing apparatus 10 generates and outputs a system utterance based on a result of the analysis.

As a result, the information processing apparatus 10 can perform dialog with an intention of a user utterance understood accurately.

The processes described above with reference to FIGS. 7 to 9 are examples of the case in which user utterances inputted newly are all feedback utterances, that is, user responses to system utterances executed n the past are performed.

The user sometimes performs not only such a feedback utterance but a new utterance having no relation to any system utterance in the past.

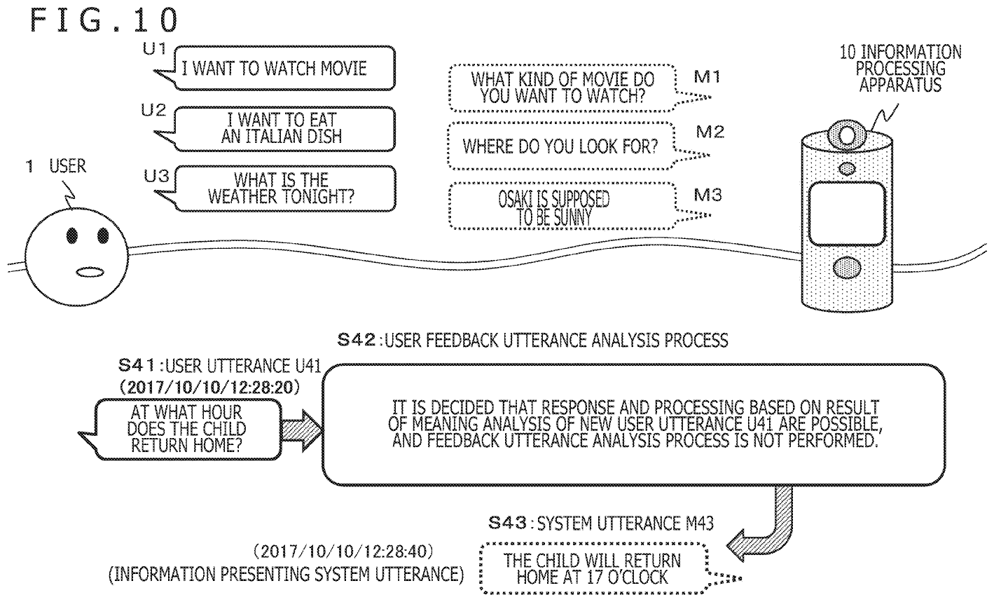

This example is described with reference to FIG. 10.

In the upper stage of FIG. 10, the dialog sequence between the user and the system described hereinabove with reference to FIG. 4 is depicted.

The dialog history corresponding to the dialog sequence is stored as user feedback utterance analysis information in the storage section 190.

In the lower stage of FIG. 10, a user utterance U11 after that is depicted.

(Step S41) (2017/10/10/12:28:20)

user utterance U41=at what hour does the child return home?

The user feedback utterance analysis section 170 of the information processing apparatus 10 analyzes the newly inputted user utterance about whether or not the user utterance is a feedback utterance corresponding to a system utterance in the past and besides to which system utterance the user utterance corresponds as a feedback utterance.

The process executed by the user feedback utterance analysis section 170 of the information processing apparatus 10 is a user feedback utterance analysis process in step S42 depicted in FIG. 10. In particular, the information processing apparatus 10 executes the following process.

The user feedback utterance analysis section 170 decides that a response and a process based on a result of meaning analysis of the user utterance U41 are possible and does not perform the feedback utterance analysis process.

In particular, in the present example, the user feedback utterance analysis section 170 acquires a response to the utterance from the user,

user utterance U41=at what hour does the child return home?

from a schedule notebook of the child and decides that the processing is completed if a response is acquired and does not perform the feedback utterance analysis process.

In the case where such a decision is made, the user feedback utterance analysis section 170 does not perform analysis of any system utterance in the past and outputs a notification that the process is not performed and a response generation request to the output information generation section 180.

The output information generation section 180 generates and outputs the following system utterance M43 in step S43 depicted in FIG. 10, on the basis of the input of them.

(Step S43) (2017/10/10/12:28:40)

system utterance M43=the child will return home at 17 o'clock

It is to be noted that the output information generation section 180 acquires schedule data of the child, for example, from an external schedule management server and generates and outputs a system response.

### 3. Other Working Examples

The working example described above is directed to an example in which a dialog history between the user and the system is used as information for analyzing the user utterance about to which system utterance executed in the past it corresponds as a feedback utterance.

Examples of a process and examples of a modification different from the working example are described.

The following three examples of a process are described.

(A) Example of a process in which image information outputted to the image outputting section 122 is applied

(B) Example of a process in which a provision function of the system (information processing apparatus 10) is taken into consideration

(C) Example of a process of the multimodal type that makes use of information inputted from an information inputting section other than the sound inputting section

(A) Example of a process in which image information outputted to the image outputting section 122 is applied

For example, if a map on which a user can select a place is displayed on the image outputting section 122, then the possibility is high that, even if a question is not issued from the system (information processing apparatus 10), the user may execute a user utterance in regard to the displayed map.

The system may be configured such that such a system process as a screen image display process is stored as a history into the storage section 190 and the user feedback utterance analysis section 170 uses the system process history of the screen image display history information and so forth stored in the storage section 190 to execute a feedback utterance analysis process.

(B) Example of a process in which a provision function of the system (information processing apparatus 10) is taken into consideration

Users in most cases grasps functions included in the system (information processing apparatus 10) including, for example, a music reproduction function, a mail transmission and reception function, a telephone function and so forth.

A user utterance has a high degree of possibility that it is related to a function that can be provided by the system.

For example, in the case where, although a certain system has a function for starting reproduction of music and a function for starting a telephone call, connection to a telephone line is not established at a current point of time, if the user utters “start xxx,” then it is considered that the possibility that the user may request not to start a telephone call but to start reproduction of music is high.

The user feedback utterance analysis section 170 may be configured so as to execute a feedback utterance analysis process taking also such information into consideration.

(C) Example of a process of the multimodal type that makes use of information inputted from an information inputting section other than the sound inputting section

The user feedback utterance analysis section 170 may be configured so as to use, for example, input information of the image inputting section 112 or the sensor 113 to execute a feedback utterance analysis process.

The user feedback utterance analysis section 170 uses various kind of context information (environment information) acquired from input information of the image inputting section 112 and the sensor 113, for example, context information (environment information) of the orientation of the face of the user, change in number of persons present in front of the camera and so forth to decide whether or not the user utterance is an utterance made to talk to the system.

The user feedback utterance analysis section 170 may be configured in the following manner. In particular, it performs the decision described above, for example, before execution of the user feedback analysis process. Then, in the case where it is decided that the user utterance is not an utterance made to talk to the system, the user feedback utterance analysis section 170 does not execute the feedback utterance analysis process, and only in the case where it is decided that the user utterance is an utterance made to talk to the system, the user feedback utterance analysis section 170 performs the feedback utterance analysis process.

### 4. Sequence of Processing Executed by Information Processing Apparatus

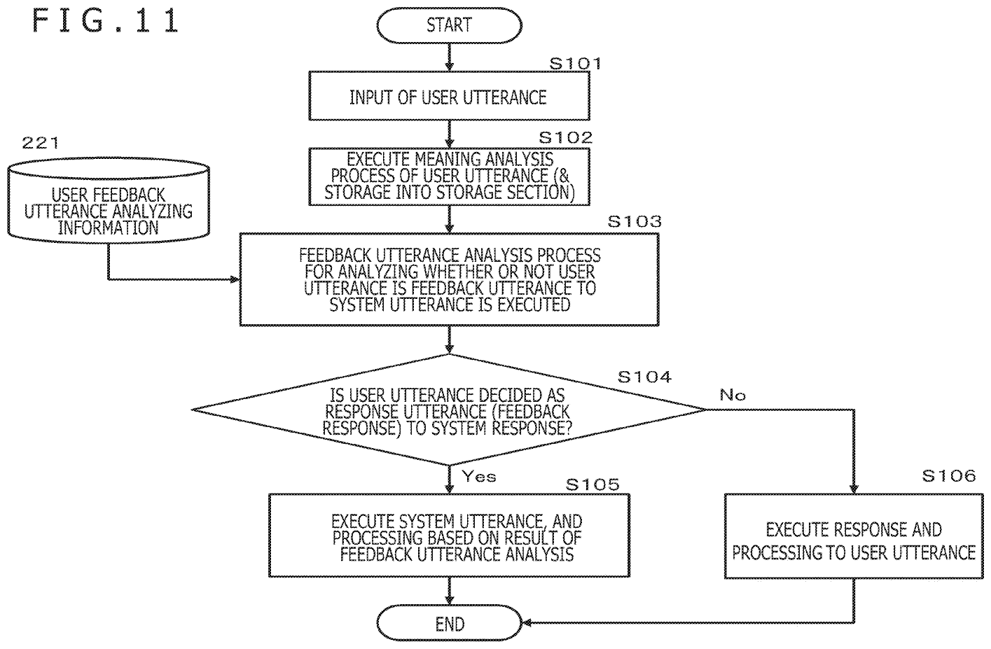

In the following, a sequence of processing executed by the information processing apparatus 10 is described with reference to flow charts of FIG. 11 and so forth.

The processes according to the flow charts of FIG. 11 and so forth are executed, for example, according to a program stored in the storage section of the information processing apparatus 1. For example, the processes can be executed as program execution processes by a processor such as a CPU having a program execution function.

First, a general sequence of processing executed by the information processing apparatus 10 is described with reference to a flowchart depicted in FIG. 11.

Processes in steps of the flow of FIG. 11 are described.

(Step S101)

First, the information processing apparatus 10 receives a user utterance as an input thereto in step S101.

This process is a process executed by the sound inputting section 111 of the information processing apparatus 10 depicted in FIG. 3.

It is to be noted that an image and sensor information are also inputted together with sound.

(Step S102)

Then in step S102, the information processing apparatus 10 executes voice recognition and meaning analysis of the user utterance. A result of the analysis is stored into the storage section.

This process is a process executed by the sound analysis section 161 of the information processing apparatus 10 depicted in FIG. 3.

It is to be noted that analysis of the image and the sensor information inputted together with the voice is also executed together.

(Steps S103 and S104)

Then in step S103, the information processing apparatus 10 executes a feedback utterance analysis process of analyzing the user utterance about whether or not it is a feedback utterance to a system utterance in the past executed precedently.

This process is a process executed by the user feedback utterance analysis section 170 of the information processing apparatus 10 depicted in FIG. 3.

The user feedback utterance analysis section 170 refers to the following information,

the “dialog history information” (user feedback utterance analyzing information (1)) depicted in FIG. 5, and

the “requested entity type information corresponding to a domain applicable for intention clarification” (user feedback utterance analyzing information (2)) depicted in FIG. 6,

to execute analysis of the user utterance.

User feedback analyzing information 221 depicted in FIG. 11 is information described hereinabove with reference to FIGS. 5 and 6 and is information stored in the storage section 190 depicted in FIG. 3.

The user feedback utterance analysis section 170 decides whether or not the user utterance is a feedback utterance (response utterance) to one of a plurality of system utterances (utterances outputted from the information processing apparatus 10) executed before that and further to which system utterance the user utterance corresponds as the feedback utterance (response utterance).

In the case where it is decided that the user utterance is a feedback utterance to a system utterance in the past (step S104=Yes), the processing advances to step S105.

On the other hand, in the case where it is decided that the user utterance is not a feedback utterance to any system utterance in the past (step S104=No), the processing advances to step S106.

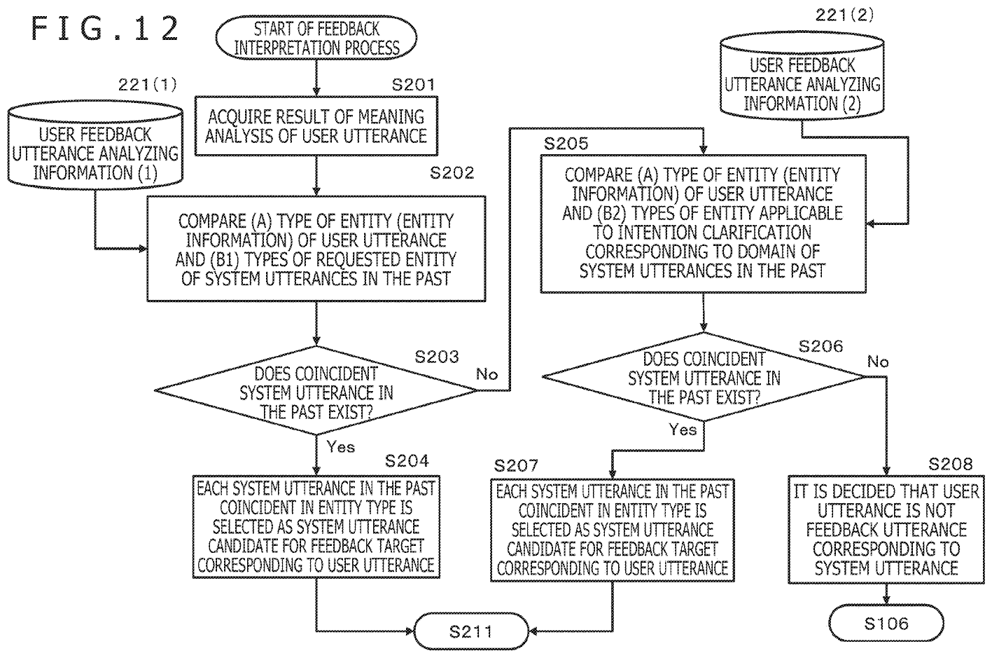

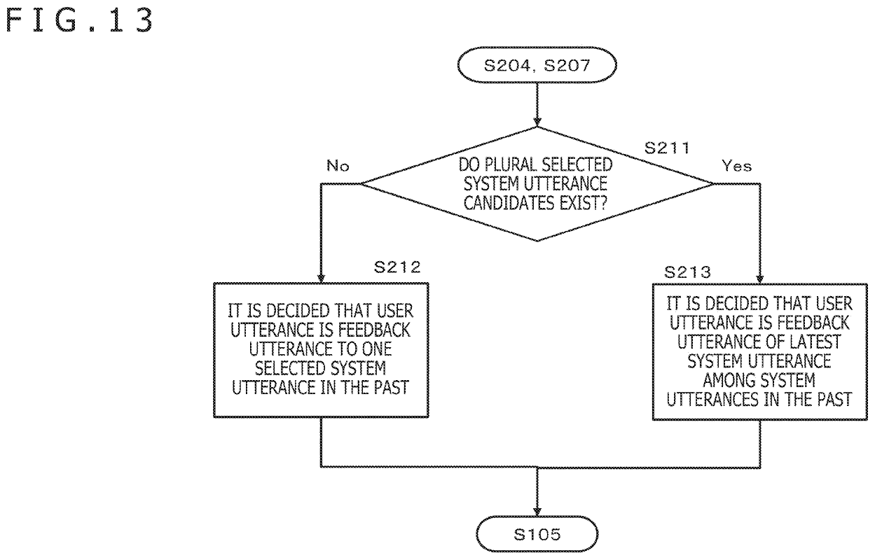

A detailed sequence of the feedback utterance analysis processes in steps S103 and S104 is hereinafter described with reference to flow charts of FIGS. 12 and 13.

(Step S105)

In the case where it is decided in steps S103 and S104 that the user utterance is a feedback utterance to a system utterance in the past, the processing advances to step S105.

In step S105, the information processing apparatus 10 executes system utterance and processing on the basis of the feedback utterance analysis result.

It is to be noted that the system response and the processing executed at this time are response and processing based on a decision that the user utterance is a feedback utterance to one certain preceding system utterance.

Accordingly, the response and the processing related to the selected one preceding system utterance are executed.

(Step S106)

On the other hand, in the case where it is decided in steps S103 and S104 that the user utterance is not a feedback utterance to any system utterance in the past, the processing advances to step S106.

In step S106, the information processing apparatus 10 executes system utterance and processing according to an intention of an ordinary user utterance that is not a feedback utterance.

It is to be noted that the system response and the processing at this time are response and processing based on a decision that the user utterance is not a feedback utterance to any one preceding system utterance.

In the following, a detailed sequence of the feedback utterance analysis process executed in steps S103 and S104 is described with reference to flow charts of FIGS. 12 and 13.

The flow charts depicted in FIGS. 12 and 13 are processes executed by the user feedback utterance analysis section 170 of the information processing apparatus 10 depicted in FIG. 3.

(Step S201)

First, the user feedback utterance analysis section 170 acquires a result of meaning analysis of a user utterance in step S201.

The result of meaning analysis of the user utterance is a result of analysis by the sound analysis section 161.

As described hereinabove, the sound analysis section 161 has, for example, an ASR (Automatic Speech Recognition) function and converts voice data into text data including a plurality of words.

Further, the sound analysis section 161 executes an utterance meaning analysis process for the text data.

The sound analysis section 161 has a natural language understanding function such as, for example, NLU (Natural Language Understating) and estimates an intention (intent: Intent) of a user utterance from text data and entity information (entity: Entity) that is significant factors (significant factors) included in the utterance.

The user feedback utterance analysis section 170 acquires such information as mentioned above relating to the user utterance.

(Steps S202 and S203)

Then, in step S202, the user feedback utterance analysis section 170 executes the following process. In particular, a comparison process between entity types, that is, between

(A) the type of the entity (entity information) of the user utterance, and

(B1) the types of requested entities of system utterances in the past is executed.

(A) The type of the entity (entity information) of the user utterance is acquired from the meaning analysis result of the user utterance acquired in step S201.

(B1) The types of requested entities of system utterances in the past are acquired from the “dialog history information” (user feedback utterance analyzing information (1)) depicted in FIG. 5.

In the case where it is decided in step S203 that

“a system utterance in the past having the type of a requested entity” that matches with “the type of the entity (entity information) of the user utterance” exists (step S203=Yes),

the processing advances to step S204.

On the other hand, in the case where it is decided that “a system utterance in the past having the type of a requested entity” that matches with “the type of the entity (entity information) of the user utterance” does not exist (step S203=No), the processing advances to step S205.

The processes in steps S202 and S203 correspond, for example, to the processes described hereinabove with reference to FIG. 7.

In the example described with reference to FIG. 7, the user feedback utterance analysis section 170 analyzes that the user utterance U11=“I want to go to Roppongi Sunday night” includes “entity type=place,” and decides, on the basis of the result of the analysis, that the system utterance M2 “where do you look for,” which inquires about a place, is a system utterance that is a feedback target (response target), to the user utterance

user utterance U11=I want to go to Roppongi Sunday night.

This decision corresponds to the Yes decision in step S203. In particular, this decision is

that “a system utterance in the past having the type of a requested entity” that matches with “the type of the entity (entity information) of the user utterance” exists (step S203=Yes), and the processing advances to step S204.

(Step S204)

If it is decided in step S203 that “a system utterance in the past having the type of a requested entity” that matches with “the type of the entity (entity information) of the user utterance” exists (step S203=Yes), then the processing advances to step S204.

In step S204, the user feedback utterance analysis section 170 selects the system utterance in the past that matches in entity type as a system utterance candidate for a feedback target corresponding to the user utterance.

It is to be noted that a plurality of system utterances is sometimes selected here.

(Steps S205 to S206)

On the other hand, if it is decided in step S203 that “a system utterance in the past having the type of a requested entity” that matches with “the type of the entity (entity information) of the user utterance” does not exist (step S203=No), then the processing advances to step S205.

The user feedback utterance analysis section 170 executes the following process in step S205. In particular, a comparison process between the entity types

(A) the type of the entity (entity information) of the user utterance, and

(B2) the types of entities applicable to intention clarification corresponding to domains of system utterances in the past

is executed.

(A) The type of the entity (entity information) of the user utterance is acquired from the meaning analysis result of the user utterance acquired in step S201.

(B2) The types of entities applicable to intention clarification corresponding to domains of system utterances in the past are acquired from the “requested entity type information corresponding to a domain applicable for intention clarification” (user feedback utterance analyzing information (2)) depicted in FIG. 6.

In the case where it is decided in step S205 that “a system utterance in the past having a type of a requested entity corresponding to a domain applicable for intention clarification” that matches with the “type of the entity (entity information) of the user utterance” exists (step S206=Yes), then the processing advances to step S207.

On the other hand, in the case where it is decided that “a system utterance in the past having a type of a requested entity corresponding to a domain applicable for intention clarification” that matches with the “type of the entity (entity information) of the user utterance” does not exist (step S206=No), then the processing advances to step S208.

The processes in steps S205 to 206 correspond, for example, to the processes described hereinabove with reference to FIG. 8.

In the example depicted with reference to FIG. 8, the user feedback utterance analysis section 170 analyzes that the user utterance U21=Sunday night?

includes the “entity type=date and time.”

Further, the user feedback utterance analysis section 170 acquires the “type of a requested entity corresponding to a domain applicable for intention clarification” in regard to each of the system utterances M1 to M3 performed before the user utterance U21.

The user feedback utterance analysis section 170 acquires the information mentioned from the “requested entity type information corresponding to a domain applicable for intention clarification” (user feedback utterance analyzing information (2)) depicted in FIG. 6.

The result of this is as follows.

The system utterance M1=“what kind of movie do you want to watch” (domain=movie search) includes “requested entity type corresponding to a domain applicable for intention clarification=date and time, place, genre.”

The system utterance M2=“where do you look for” (domain=restaurant search) includes “requested entity type information corresponding to a domain applicable for intention clarification=date and time, place, genre.”

The system utterance M3=“Osaki is supposed to be sunny” (domain=weather information check) includes “requested entity type information corresponding to a domain applicable for intention clarification=date and time, place, genre.”

In the example depicted in FIG. 8, it is decided that

all of the system utterances M1 to M3 include

“requested entity type information corresponding to a domain applicable for intention clarification=date and time, place, genre.”

This decision is a decision that “there is a system utterance in the past having a requested entity type corresponding to a domain applicable for intention clarification” coincident with the “type of the entity (entity information) of the user utterance” (step S206=Yes), and the processing advances to step S207.

(Step S207)

If it is decided in step S206 that the “there is a system utterance in the past having a requested entity type corresponding to a domain applicable for intention clarification” coincident with the “type of the entity (entity information) of the user utterance” (step S206=Yes), then the processing advances to step S207.

In step S207, the user feedback utterance analysis section 170 selects the system utterance in the past coincident in entity type as a system utterance candidate of a feedback target corresponding to the user utterance.

It is to be noted that a plurality of system utterances is sometimes selected here.

In the case of the example depicted in FIG. 8, the three system utterances M1 to M3 are selected as candidates.

(Step S208)

On the other hand, in the case where it is decided in step S206 that there is not “a system utterance in the past having a requested entity type corresponding to a domain applicable for intention clarification” coincident with the “type of the entity (entity information) of the user utterance” (step S206=No), then the processing advances to step S208.

In step S208, the user feedback utterance analysis section 170 decides that the user utterance is not a feedback utterance to any system utterance in the past.

If this decision is made, then the processing advances to step S106 of the flow described hereinabove with reference to FIG. 11.

In step S106, the information processing apparatus 10 executes system utterance and processing according to an intention of an ordinary user utterance that is not a feedback utterance.

(Step S211)

If a candidate for a system utterance that becomes a feedback target corresponding to the user utterance is selected in any of step S204 or step S207, then the processing advances to step S211.

In step S211, the user feedback utterance analysis section 170 decides whether or not a plurality of system utterances that become a feedback target corresponding to the user utterance is selected in any of step S204 or step S207.

In the case where only one system utterance that becomes a feedback target corresponding to the user utterance is selected, the processing advances to step S212.

On the other hand, in the case where a plurality of system utterances that become a feedback target corresponding to the user utterance is selected, the processing advances to step S213.

(Step S212)

In the case where only one system utterance that becomes a feedback target corresponding to the user utterance is selected, the following decision is made in step S212.

It is decided that the user utterance is a feedback utterance to the one selected system utterance in the past.

(Step S213)

On the other hand, in the case where a plurality of system utterances that become a feedback target corresponding to the user utterance is selected, the following decision is made in step S213.

It is decided that the user utterance is a feedback utterance to the latest system utterance from among the plural selected system utterances in the past.

After one system utterance that is to be made a feedback target to the user utterance is decided in step S212 or step S213, the processing advances to S105 from step S203 of the flow described hereinabove with reference to FIG. 11.

In step S105, the information processing apparatus 10 executes system utterance and processing on the basis of the result of the feedback utterance analysis.

It is to be noted that the system response and the processing executed at this time are response and processing that are based on the decision that the user utterance is a feedback utterance to a certain preceding system utterance.

Accordingly, response and processing related to the selected one preceding system utterance are executed.

### 5. Example of Configuration of Information Processing Apparatus and Information Processing System

While the processes executed by the information processing apparatus 10 of the present disclosure are described, almost all of the processing functions of the components of the information processing apparatus 10 depicted in FIG. 3 can be configured in one apparatus, for example, in an agent apparatus owned by a user or a device such as a smartphone or a PC. However, it is also possible to apply a configuration in which part of the processing functions are executed in a server or the like.

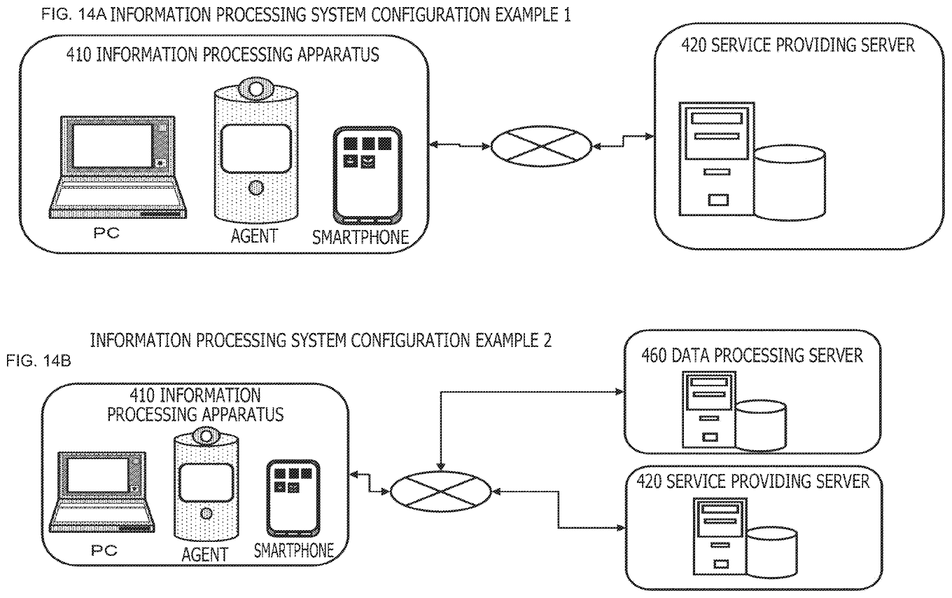

Examples of a system configuration are depicted in FIG. 14.

An information processing system configuration example 1 of FIG. 14(1) is an example in which almost all of the functions of the information processing apparatus depicted in FIG. 3 are configured in one apparatus such as, for example, an information processing apparatus 410 that is a user terminal such as a smartphone or a PC owned by a user or an agent apparatus or the like having sound inputting/outputting and image inputting/outputting functions.

The information processing apparatus 410 corresponding to a user terminal executes communication with a service providing server 420, for example, only where an external service is utilized upon response sentence generation.

The service providing server 420 is, for example, a music providing server, a content providing server of a movie and so forth, a game server, a weather information providing server, a traffic information providing server, a medical information providing server, a sightseeing information providing server or the like and is including a server group capable of providing information necessitated for execution of a process for a user utterance or response generation.

On the other hand, an information processing system configuration example 2 of FIG. 14(2) is a system example in which part of the functions of the information processing apparatus depicted in FIG. 3 are configured in the information processing apparatus 410 that is a user terminal such as a smartphone or a PC owned by a user or an agent apparatus or the like, and part of the functions are executed in a data processing server 460 capable of communicating the information processing apparatus.

For example, such a configuration can be applied that only the inputting section 110 and the outputting section 120 in the apparatus depicted in FIG. 3 are provided on the information processing apparatus 410 side on the user terminal side and all of the remaining functions are executed by the server side.

It is to be noted that various different settings can be applied to the function division form of the functions on the user terminal side and the functions on the server side, and such a configuration can also be implemented that one function is executed by both of them.

### 6. Example of Hardware Configuration of Information Processing Apparatus

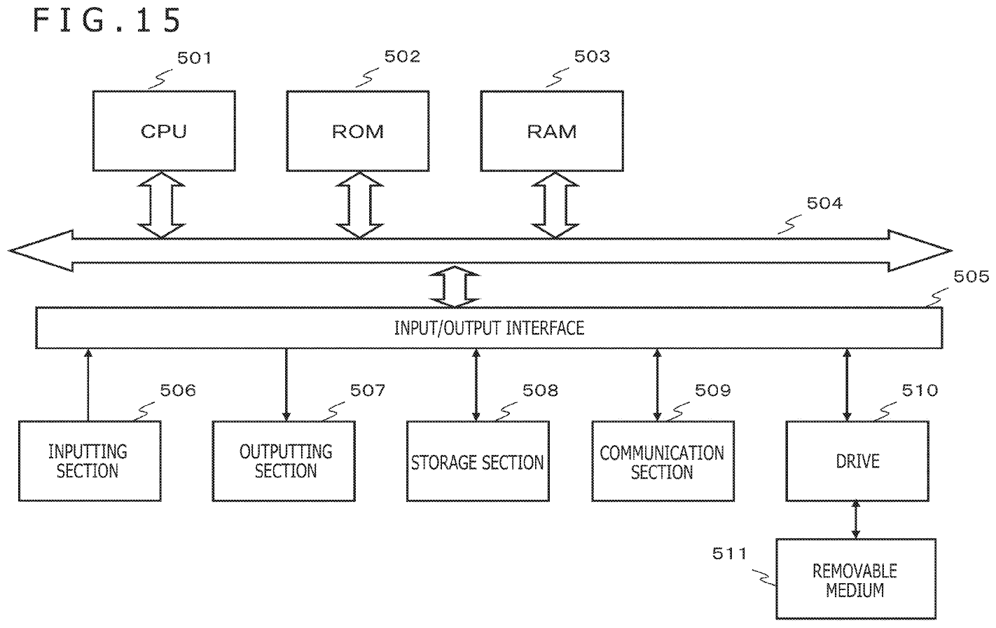

Now, an example of a hardware configuration of the information processing apparatus is described with reference to FIG. 15.

The hardware described with reference to FIG. 15 is an example of a hardware configuration of the information processing apparatus described hereinabove with reference to FIG. 3 and is an example of a hardware configuration of the information processing apparatus that configures the data processing server 460 described hereinabove with reference to FIG. 14.

A CPU (Central Processing Unit) 501 functions as a control section or a data processing section that executes various processes according to a program stored in a ROM (Read Only Memory) 502 or a storage section 508. For example, the processes according to the sequences described hereinabove in connection with the working example are executed. A program to be executed by the CPU 501, data and so forth are stored into a RAM (Random Access Memory) 503. The CPU 501, ROM 502, and RAM 503 are connected to each other through a bus 504.

The CPU 501 is connected to an input/output interface 505 through the bus 504, and an inputting section 506 including various switches, a keyboard, a mouse, a microphone, a sensor and so forth and an outputting section 507 including a display, a speaker and so forth are connected to the input/output interface 505. The CPU 501 executes various processes according to an instruction inputted from the inputting section 506 and outputs a result of the processes, for example, to the outputting section 507.

The storage section 508 connected to the input/output interface 505 is configured, for example, from a hard disk or the like and stores a program to be executed by the CPU 501 and various kinds of data. A communication section 509 functions as a transmission and reception section for data communication through Wi-Fi communication, Bluetooth (registered trademark) (BT) communication, or a network such as the Internet or a local area network and communicates with an external apparatus.

A drive 510 connected to the input/output interface 505 drives a removable medium 511 such as a magnetic disk, an optical disk, a magneto-optical disk, a semiconductor memory such as a memory card or the like and executes recording or reading out of data.

### 7. Summary of Configuration of Present Disclosure

The working example of the present disclosure has been described in detail while referring to the specific working example. However, it is apparent that modification or substitution of the working example can be made by those skilled in the art without departing from the spirit or scope of the present disclosure. In particular, the present invention is disclosed by way of illustration and shall not be interpreted restrictively. In order to decide the subject matter of the present disclosure, the claims should be referred to.

It is to be noted that the technology disclosed in the present specification can be configured in such a manner as described below.

(1)

An information processing apparatus, including:

a user feedback utterance analysis section configured to decide whether or not a user utterance is a feedback utterance as a response to a past system utterance (utterance of the information processing apparatus) executed precedingly, in which

the user feedback utterance analysis section analyzes a relevance between the user utterance and system utterances in the past to select a system utterance having a high relevance, as a system utterance of a feedback target of the user utterance.

(2)

The information processing apparatus according to (1), in which

the user feedback utterance analysis section executes a comparison process of entity types of (A) and (B1)

(A) a type of an entity (entity information) included in the user utterance, and

(B1) a type of a requested entity corresponding to a system utterance that is an entity requested to the user by the system utterance in the past, and

selects a system utterance having a type of a requested entity that matches with the type of the entity included in the user utterance, as a system utterance of a feedback target of the user utterance.

(3)

The information processing apparatus according to (2), in which

where there is a plurality of system utterances having the type of the requested entity that matches with the type of the entity included in the user utterance,

a latest system utterance from among the system utterances having the type of the requested entity that matches with the type of the entity included in the user utterance is selected as the system utterance of the feedback target of the user utterance.

(4)

The information processing apparatus according to any one of (1) to (3), in which

the user feedback utterance analysis section executes a comparison process of entity types of (A) and (B2)

(A) a type of an entity (entity information) included in the user utterance, and

(B2) a type of a requested entity corresponding to a domain applicable for intention clarification of each system utterance in the past, and

selects a system utterance having a type of a requested entity corresponding to a domain applicable for intention clarification that matches with the type of the entity included in the user utterance, as a system utterance of a feedback target of the user utterance.

(5)

The information processing apparatus according to (4), in which

where there is a plurality of system utterances having the type of the requested entity corresponding to the domain applicable for intention clarification that matches with the type of the entity included in the user utterance,

a latest system utterance from among system utterances having the type of the requested entity corresponding to the domain applicable for intention clarification that matches with the type of the entity included in the user utterance is selected as the system utterance of the feedback target of the user utterance.

(6)

The information processing apparatus according to any one of (1) to (5), in which

the information processing apparatus includes a storage section in which dialog history information executed between the user and the information processing apparatus is stored, and

the user feedback utterance analysis section applies the utterance history information stored in the storage section to execute a selection process of a system utterance of a feedback target of the user utterance.

(7)

The information processing apparatus according to (6), in which

the utterance history information stored in the storage section includes a domain of the system utterance and requested entity information, as recorded information.

(8)

The information processing apparatus according to any one of (1) to (7), in which

the information processing apparatus includes a storage section in which association data between domains of system utterances and types of requested entities corresponding to a domain applicable for intention clarification are stored, and

the user feedback utterance analysis section applies the storage data of the storage section to execute the selection process of the system utterance of the feedback target of the user utterance.

(9)

The information processing apparatus according to any one of (1) to (8), in which

the user feedback utterance analysis section acquires a type of an entity (entity information) included in the user utterance from a sound analysis result of the user utterance.

(10)

The information processing apparatus according to any one of (1) to (9), in which

the user feedback utterance analysis section applies acquisition information of an image inputting section or a sensor to execute the selection process of the system utterance of the feedback target of the user utterance.

The information processing apparatus according to any one of (1) to (10), in which

the user feedback utterance analysis section applies output information of an outputting section or function information of the information processing apparatus to execute the selection process of the system utterance of the feedback target of the user utterance.

(12)

An information processing system including:

a user terminal; and

a data processing server, in which

the user terminal includes a sound inputting section for inputting a user utterance, and

the data processing server includes a user feedback utterance analysis section that decides whether or not the user utterance received from the user terminal is a feedback utterance as a response to a past system utterance (utterance of the user terminal) executed precedingly,

the user feedback utterance analysis section analyzing a relevance between the user utterance and system utterances in the past and selects a system utterance having a high relevance, as a system utterance of a feedback target of the user utterance.

(13)

An information processing method that is executed by an information processing apparatus, in which

the information processing apparatus includes a user feedback utterance analysis section configured to decide whether or not a user utterance is a feedback utterance as a response to a past system utterance (utterance of the information processing apparatus) in the past executed precedingly,

the user feedback utterance analysis section analyzing a relevance between the user utterance and system utterances in the past to select a system utterance having a high relevance, as a system utterance of a feedback target of the user utterance.

(14)

An information processing method that is executed in an information processing system including a user terminal and a data processing server, in which

the user terminal executes a sound inputting process for inputting a user utterance, and

the data processing server includes a user feedback utterance analysis process for deciding whether or not the user utterance received from the user terminal is a feedback utterance as a response to a past system utterance (utterance of the user terminal) in the past executed precedingly,

the user feedback utterance analysis process analyzing a relevance between the user utterance and system utterances in the past, and selects a system utterance having a high relevance, as a system utterance of a feedback target of the user utterance.

(15)

A program for causing an information processing apparatus to execute an information process, in which

the information processing apparatus includes a user feedback utterance analysis section configured to decide whether or not a user utterance is a feedback utterance as a response to a past system utterance (utterance of the information processing apparatus) executed precedingly, and

the program causes the user feedback utterance analysis section to analyze a relevance between the user utterance and system utterances in the past to select a system utterance having a high relevance, as a system utterance of a feedback target of the user utterance.

Further, the series of processes described in the specification can be executed by hardware, software, or a composite configuration of them. Where processing by software is executed, a program in which a processing sequence is recorded can be installed into a memory of a computer incorporated in hardware for exclusive use and executed or a program can be installed into and executed by a computer for universal use that can execute various processes. For example, the program can be recorded in advance on a recording medium. The program can not only be installed from a recording medium into a computer and but can also be received through a network such as a LAN (Local Area Network) or the Internet and installed into a recording medium such as a hard disk built therein.

It is to be noted that the various processes described in the specification not only may be executed in a time series according to the description but also may be executed in parallel or individually according to a processing capacity of an apparatus that executes the process or as occasion demands. Further, the system in the present specification is a logical aggregation configuration of a plurality of devices and is not limited to a system in which apparatuses of the various configurations are provided in the same housing.

### INDUSTRIAL APPLICABILITY

As described above, with the configuration of the working example of the present disclosure, an apparatus and a method which analyze a user utterance with high accuracy about to which one of a plurality of system utterances performed precedingly the user utterance corresponds as a feedback utterance are implemented.

In particular, for example, a user feedback utterance analysis section which decides to which one of system utterances executed precedingly the user utterance corresponds as a feedback utterance is provided. The user feedback utterance analysis section compares (A) a type of an entity (entity information) included in the user utterance and (B1) types of requested entities corresponding to system utterances in which a system utterance in the past is an entity to be requested to the user, and a system utterance having a requested entity type that matches with the entity type included in the user utterance is determined as a system utterance of a feedback target of the user utterance.

With the present configuration, an apparatus and a method which analyze with high accuracy about to which one of a plurality of system utterances performed precedingly the user utterance corresponds as a feedback utterance are implemented.

### REFERENCE SIGNS LIST

10 Information processing apparatus
11 Camera
12 Microphone
13 Display section
14 Speaker
20 Server
30 External apparatus
110 Inputting section
111 Sound inputting section
112 Image inputting section
113 Sensor
120 Outputting section
121 Sound outputting section
122 Image outputting section
150 Data processing section
140 Input data analysis section
161 Sound analysis section
162 Image analysis section
163 Sensor information analysis section
170 User feedback utterance analysis section
180 Output information generation section
181 Output sound generation section
182 Display information generation section
190 Storage section
410 Information processing apparatus
420 Service providing server
460 Data processing server
501 CPU
502 ROM
503 RAM
504 Bus
505 Input/output interface
506 Inputting section
507 Outputting section
508 Storage section
509 Communication section
510 Drive
511 Removable medium

1. An information processing apparatus, comprising:
a user feedback utterance analysis section configured to decide whether or not a user utterance is a feedback utterance as a response to a past system utterance, i.e., utterance of the information processing apparatus, executed precedingly, wherein
the user feedback utterance analysis section analyzes a relevance between the user utterance and system utterances in the past to select a system utterance having a high relevance, as a system utterance of a feedback target of the user utterance.

2. The information processing apparatus according to claim 1, wherein
the user feedback utterance analysis section executes a comparison process of entity types of (A) and (B1)
(A) a type of an entity, i.e., entity information, included in the user utterance, and
(B1) a type of a requested entity corresponding to a system utterance that is an entity requested to the user by the system utterance in the past, and
selects a system utterance having a type of a requested entity that matches with the type of the entity included in the user utterance, as a system utterance of a feedback target of the user utterance.

3. The information processing apparatus according to claim 2, wherein
where there is a plurality of system utterances having the type of the requested entity that matches with the type of the entity included in the user utterance,
a latest system utterance from among the system utterances having the type of the requested entity that matches with the type of the entity included in the user utterance is selected as the system utterance of the feedback target of the user utterance.

4. The information processing apparatus according to claim 1, wherein
the user feedback utterance analysis section executes a comparison process of entity types of (A) and (B2)
(A) a type of an entity, i.e., entity information, included in the user utterance, and
(B2) a type of a requested entity corresponding to a domain applicable for intention clarification of each system utterance in the past, and
selects a system utterance having a type of a requested entity corresponding to a domain applicable for intention clarification that matches with the type of the entity included in the user utterance, as a system utterance of a feedback target of the user utterance.

5. The information processing apparatus according to claim 4, wherein
where there is a plurality of system utterances having the type of the requested entity corresponding to the domain applicable for intention clarification that matches with the type of the entity included in the user utterance,
a latest system utterance from among system utterances having the type of the requested entity corresponding to the domain applicable for intention clarification that matches with the type of the entity included in the user utterance is selected as the system utterance of the feedback target of the user utterance.

6. The information processing apparatus according to claim 1, wherein
the information processing apparatus includes a storage section in which dialog history information executed between the user and the information processing apparatus is stored, and
the user feedback utterance analysis section applies the utterance history information stored in the storage section to execute a selection process of a system utterance of a feedback target of the user utterance.

7. The information processing apparatus according to claim 6, wherein
the utterance history information stored in the storage section includes a domain of the system utterance and requested entity information, as recorded information.

8. The information processing apparatus according to claim 1, wherein
the information processing apparatus includes a storage section in which association data between domains of system utterances and types of requested entities corresponding to a domain applicable for intention clarification stored, and
the user feedback utterance analysis section applies the storage data of the storage section to execute the selection process of the system utterance of the feedback target of the user utterance.

9. The information processing apparatus according to claim 1, wherein
the user feedback utterance analysis section acquires a type of an entity, i.e., entity information, included in the user utterance from a sound analysis result of the user utterance.

10. The information processing apparatus according to claim 1, wherein
the user feedback utterance analysis section applies acquisition information of an image inputting section or a sensor to execute the selection process of the system utterance of the feedback target of the user utterance.

11. The information processing apparatus according to claim 1, wherein
the user feedback utterance analysis section applies output information of an outputting section or function information of the information processing apparatus to execute the selection process of the system utterance of the feedback target of the user utterance.

12. An information processing system comprising:
a user terminal; and
a data processing server, wherein
the user terminal includes a sound inputting section for inputting a user utterance, and
the data processing server includes a user feedback utterance analysis section that decides whether or not the user utterance received from the user terminal is a feedback utterance as a response to a past system utterance, i.e., utterance of the user terminal, executed precedingly,
the user feedback utterance analysis section analyzing a relevance between the user utterance and system utterances in the past and selects a system utterance having a high relevance, as a system utterance of a feedback target of the user utterance.

13. An information processing method that is executed by an information processing apparatus, wherein
the information processing apparatus includes a user feedback utterance analysis section configured to decide whether or not a user utterance is a feedback utterance as a response to a past system utterance, i.e., utterance of the information processing apparatus executed precedingly,
the user feedback utterance analysis section analyzing a relevance between the user utterance and system utterances in the past to select a system utterance having a high relevance, as a system utterance of a feedback target of the user utterance.

14. An information processing method that is executed in an information processing system including a user terminal and a data processing server, wherein
the user terminal executes a sound inputting process for inputting a user utterance, and
the data processing server includes a user feedback utterance analysis process for deciding whether or not the user utterance received from the user terminal is a feedback utterance as a response to a past system utterance, i.e., utterance of the user terminal, executed precedingly,
the user feedback utterance analysis process analyzing a relevance between the user utterance and system utterances in the past, and selects a system utterance having a high relevance, as a system utterance of a feedback target of the user utterance.

15. A program for causing an information processing apparatus to execute an information process, wherein
the information processing apparatus includes a user feedback utterance analysis section configured to decide whether or not a user utterance is a feedback utterance as a response to a past system utterance, i.e., utterance of the information processing apparatus, executed precedingly, and
the program causes the user feedback utterance analysis section to analyze a relevance between the user utterance and system utterances in the past to select a system utterance having a high relevance, as a system utterance of a feedback target of the user utterance.
